(19) United States
(12) Patent Application Publication
(10) Pub. No.: US 2011/0129245 A1
(43) Pub. Date: Jun. 2, 2011

(54) EXPOSURE HEAD AND IMAGE FORMING APPARATUS

(75) Inventors: Takeshi SOWA, Matsumoto (JP); Ken IKUMA, Suwa (JP); Ryuta KOIZUMI, Shiojiri (JP); Nozomu INOUE, Matsumoto (JP)

(73) Assignee: SEIKO EPSON CORPORATION, Tokyo (JP)

(21) Appl. No.: 12/950,561

(22) Filed: Nov. 19, 2010

(30) Foreign Application Priority Data
Dec. 1, 2009 (JP) 2009-273127

(51) Int. Cl. G03G 15/043

(52) U.S. Cl. 399/51; 399/220

(57) ABSTRACT

A exposure head includes: a light-emitting element substrate including a first light-emitting element configured to emit light, a second light-emitting element disposed in a first direction of the first light-emitting element, a third light-emitting element, and a fourth light-emitting element disposed so as to satisfy the following relationship; Dr12:Dr23=1:m (l≠m) where, l: positive integer number, m: positive integer number, Dr12: distance between the first light-emitting element and the third light-emitting element in the direction orthogonal to the first direction, Dr23: distance between the third light-emitting element and the fourth light-emitting element in the direction orthogonal to the first direction, and an imaging optical system configured to image lights emitted from the first light-emitting element, the second light-emitting element, the third light-emitting element, and the fourth light-emitting element.

### BACKGROUND

1. Technical Fields

The present invention relates to an exposure head configured to image lights from light-emitting elements by an imaging optical system and an image forming apparatus using the exposure head.

2. Related Art

In JP-A-2009-098613, an exposure head including a light-emitting element group having a plurality of light-emitting elements aligned in a primary scanning direction and an imaging optical system opposing the light-emitting element group is disclosed. In other words, the exposure head is configured to irradiate an exposed surface with light spots by imaging the lights from the light-emitting elements by the imaging optical system. Then, by imaging the lights from the plurality of light-emitting elements in the light-emitting element group by the imaging optical system, a plurality of the spots are directed to different positions from each other in the primary scanning direction, so that the portions irradiated with the respective spots are exposed. When forming a latent image on the surface of a latent image carrier such as a photosensitive drum, a desired latent image can be formed by causing the respective light-emitting elements in the light-emitting element group to emit lights at timings according to the movement of the surface of the latent image carrier while moving the surface of the latent image carrier in a secondary scanning direction.

In the exposure head as described above, it is preferable to increase the dimensions (diameter and surface area) of the light-emitting elements in order to secure a sufficient amount of light to be used for forming the spots. However, it is difficult to increase the dimensions of the respective light-emitting elements sufficiently only by arranging the plurality of light-emitting elements in line. Therefore, in this exposure head, the plurality of light-emitting elements are arranged two-dimensionally in a plane including the primary scanning direction and the secondary scanning direction. More specifically, in the respective light-emitting element groups, the plurality of the light-emitting elements are arranged in two rows in a zigzag pattern in the primary scanning direction. In other words, two rows of the light-emitting elements arranged linearly in the primary scanning direction (light-emitting element rows) are arranged in the secondary scanning direction.

JP-A-2009-098613 is an example of related art.

It is also conceivable to configure one light-emitting element group to have three or more rows of the light-emitting element rows arranged in the secondary scanning direction. However, there is a problem as described below in order to arrange three or more light-emitting element rows. In the light-emitting element group, it is necessary to set the distance between the light-emitting element rows adjacent in the secondary scanning direction so as to avoid the interference between the light-emitting element rows. However, in a configuration in which the three light-emitting element rows are disposed in the secondary scanning direction, arrangement of the three light-emitting element rows at equal distances (regular intervals) in the secondary scanning direction may be difficult if an attempt is made to avoid the interference between the light-emitting element rows and to secure the dimensions of the light-emitting elements to be sufficiently large. Therefore, in such a case, the distance between the first row and the second row in the secondary scanning direction and the distance between the second row and the third row in the secondary scanning direction are obliged to be set differently from each other. In other words, the three light-emitting element rows are disposed at positions different from each other in the secondary scanning direction and, in addition, the distances between the light-emitting element rows in the secondary scanning direction cannot be equalized.

However, in order to cause the respective light-emitting elements arranged in the three light-emitting element rows in this manner to emit lights at timings according to the movement of the surface of the latent image carrier in the secondary scanning direction, the necessity to cause the three light-emitting elements which belong to different light-emitting element rows to emit lights at different timings arises, so that light-emitting timing control of the light-emitting elements becomes complicated.

### SUMMARY

An advantage of some aspects of the invention is to provide a technology to simplify light-emitting timing control of light-emitting elements.

An exposure head according to a first aspect of the invention includes:

a light-emitting element substrate including a first light-emitting element configured to emit light, a second light-emitting element disposed in a first direction of the first light-emitting element, a third light-emitting element, and a fourth light-emitting element disposed so as to satisfy the following relationship;

Dr12:Dr23=1:m (l≠m)

where,

l: positive integer number

m: positive integer number

Dr12: distance between the first light-emitting element and the third light-emitting element in the direction orthogonal to the first direction

Dr23: distance between the third light-emitting element and the fourth light-emitting element in the direction orthogonal to the first direction, and

an imaging optical system configured to image lights emitted from the first light-emitting element, the second light-emitting element, the third light-emitting element, and the fourth light-emitting element.

In the invention (exposure head) configured as described above, the first light-emitting element and the second light-emitting element are disposed in the first direction to constitute a light-emitting element row, and the first light-emitting element, the third light-emitting element, and the fourth light-emitting element are disposed at different positions in the direction orthogonal to the first direction (orthogonal direction). The distance Dr12 between the first light-emitting element and the third light-emitting element in the orthogonal direction and the distance Dr23 between the third light-emitting element and the fourth light-emitting element in the orthogonal direction are different from each other. Therefore, as described above, the necessity to cause the first light-emitting element, the third light-emitting element, and the fourth light-emitting element to emit lights at timings different from each other arises, so that light-emitting timing control may be complicated. In contrast, according to the first aspect of the invention, the light-emitting elements are disposed to satisfy the relationship;

Dr12:Dr23=1:m (l≠m)

where,

l: positive integer number

m: positive integer number

Dr12: distance between the first light-emitting element and the third light-emitting element in the direction orthogonal to the first direction

Dr23: distance between the third light-emitting element and the fourth light-emitting element in the direction orthogonal to the first direction.

Therefore, the light-emitting timing control such that the first light-emitting element, the second light-emitting element, the third light-emitting element, and the fourth light-emitting element are caused to emit lights at the common timing can be applied, so that the light-emitting timing control is simplified.

The integer number 1 and the integer number m may be configured to satisfy the following relationship;

m=1+1. Accordingly, the dimensions of the first light-emitting element, the second light-emitting element, the third light-emitting element, and the fourth light-emitting element are increased so as to secure the amount of light used for spot formation.

The integer number 1 and the integer number m may be configured to satisfy the following relationship;

m>1, and the light-emitting element substrate includes a drive circuit configured to drive the third light-emitting element between the third light-emitting element and the fourth light-emitting element in the direction orthogonal to the first direction. In this manner, with the configuration in which the integer 1 and the integer m satisfy the relationship m>1, that is, the distance Dr23 is set to be larger than the distance Dr12, and a relatively large space can be provided between the third light-emitting element and the fourth light-emitting element, so that the drive circuit for driving the third light-emitting element can be disposed in this space.

The integer number m and the integer number 1 may be configured to satisfy the following relationship; m>2×1. In other words, in this configuration, the distance Dr23 is set to be larger than the distance Dr12, so that a larger space can be provided between the third light-emitting element and the fourth light-emitting element. Consequently, the drive circuit can be disposed with sufficient room, so that the layout of the drive circuit is facilitated.

A fifth light-emitting element disposed in the direction different from the first direction of the first light-emitting element may be configured to be disposed on the light-emitting element substrate so as to satisfy the following relationship;

Dr12:Dr23:Dr34=l:m:n

### Where,

n: positive integer number

Dr34: distance between the fourth light-emitting element and the fifth light-emitting element in the direction orthogonal to the first direction. Accordingly, the light-emitting timing control such that the first light-emitting element, the second light-emitting element, the third light-emitting element, the fourth light-emitting element, and the fifth light-emitting element are caused to emit lights at the common timing can be applied, so that the light-emitting timing control is simplified.

Preferably, the integer number 1, the integer number m, and the integer number n have the following expression;

l=n=m+1. Accordingly, the dimensions of the first light-emitting element, the second light-emitting element, the third light-emitting element, the fourth light-emitting element, and the fifth light-emitting element are increased so as to secure the amount of light used for the spot formation.

An image forming apparatus according to a second aspect of the invention is includes:

an exposure head having:
a light-emitting element substrate including a first light-emitting element configured to emit light, a second light-emitting element disposed in a first direction of the first light-emitting element, a third light-emitting element, and a fourth light-emitting element disposed so as to satisfy the following relationship;

Dr12:Dr23=1:m (l≠m)

where,
l: positive integer number
m: positive integer number
Dr12: distance between the first light-emitting element and the third light-emitting element in the direction orthogonal to the first direction
Dr23: distance between the third light-emitting element and the fourth light-emitting element in the direction orthogonal to the first direction, and
an imaging optical system configured to image lights emitted from the first light-emitting element, the second light-emitting element, the third light-emitting element, and the fourth light-emitting element, and form a spot;

a photosensitive drum having an axis and being irradiated with the spot to form a latent image;

a control unit configured to cause the first light-emitting element, the second light-emitting element, the third light-emitting element, and the fourth light-emitting element to emit lights at a timing according to the movement of the surface of the photosensitive drum in the direction orthogonal to the direction of the axis; and

a developing unit configured to develop the latent image formed on the photosensitive drum.

In the invention (image forming apparatus) configured as described above, the first light-emitting element, the second light-emitting element, the third light-emitting element, and the fourth light-emitting element are caused to emit lights at timings according to the movement of the surface of the photosensitive drum in the direction orthogonal to the direction of an axis (orthogonal direction). In addition, the first light-emitting element, the third light-emitting element, and the fourth light-emitting element are disposed at positions different in the orthogonal direction. The distance Dr12 between the first light-emitting element and the third light-emitting element in the orthogonal direction and the distance Dr23 between the third light-emitting element and the fourth light-emitting element in the orthogonal direction are different from each other. Therefore, as described above, in order to cause the first light-emitting element, the second light-emitting element, and the fourth light-emitting element to emit light at timings according to the movement of the surface of the photosensitive drum in the orthogonal direction, the necessity to cause the first light-emitting element, the third light-emitting element, and the fourth light-emitting element to emit lights at timings different from each other arises, so that the light-emitting timing control may be complicated. In contrast, according to the second aspect of the invention, the light-emitting elements are disposed to satisfy the following relationship;

Dr12:Dr23=1:m (l≠m)

where,
l: positive integer number
m: positive integer number
Dr12: distance between the first light-emitting element and the third light-emitting element in the direction orthogonal to the first direction
Dr23: distance between the third light-emitting element and the fourth light-emitting element in the direction orthogonal to the first direction. Therefore, the light-emitting timing control such that the first light-emitting element, the second light-emitting element, the third light-emitting element, and the fourth light-emitting element are caused to emit lights at the common timing can be applied, so that the light-emitting timing control is simplified.

The imaging optical system may be configured to image the lights emitted from the first light-emitting element, the second light-emitting element, the third light-emitting element, and the fourth light-emitting element at a magnification of βs, and

the distance Dr12 and the distance Dr23 may have the following relationship;

Dr12=l×Pdt/|βs|

Dr23=m×Pdt/|βs|

Pdt: pitch of the spots directed on the photosensitive drum from the exposure head in the direction orthogonal to the first direction. Accordingly, the first light-emitting element, the second light-emitting element, the third light-emitting element, and the fourth light-emitting element can be caused to emit lights at the common timing to irradiate the photosensitive drum with the spots. Therefore, the light-emitting timing control is simplified.

### BRIEF DESCRIPTION OF THE DRAWINGS

The invention will be described with reference to the accompanying drawings, wherein like numbers reference like elements.

FIG. 1 is a plan view showing an example of a line head to which the invention can be applied.

FIG. 2 is a partial stepped cross-sectional view showing the example of the line head to which the invention can be applied.

FIG. 3 is a stepped cross-sectional view of a light-shielding member taken along the line III-III.

FIG. 4 is an exploded perspective view of the light-shielding member.

FIG. 5 is a partial plan view showing a mode of arrangement of the light-emitting elements in a light-emitting element group.

FIG. 6 is a block diagram showing an electric configuration of the line head.

FIG. 7 is a table showing lens data of an imaging optical system.

FIG. 8 shows data for providing a surface shape of S4 surface in FIG. 7.

FIG. 9 shows data for providing a surface shape of S7 in FIG. 7.

FIG. 10 shows an optical path of the imaging optical system taken along the primary direction.

FIG. 11 shows the optical path of the imaging optical system taken along the secondary direction.

FIG. 12 is a table showing a substance-side numerical aperture and a magnification in a secondary direction of the imaging optical system.

FIG. 13 is a plan view showing a configuration of the light-emitting element group.

FIG. 14 is a plan view showing a light-emitting element group in which the distances Dr12, Dr34, and Dr23 are equal.

FIG. 15 is a plan view showing a configuration of a spot group.

FIG. 16 is a drawing showing exposing actions at timings T1 and T2.

FIG. 17 is a drawing showing exposing actions at timings T3 and T4.

FIG. 18 is a drawing showing exposing actions at timings T5 and T6.

FIG. 19 is a drawing showing exposing actions at timings T7 and T8.

FIG. 20 is a drawing showing an example of an image forming apparatus to which the line head described above can be applied.

FIG. 21 is a block diagram showing an electric configuration of the apparatus shown in FIG. 20.

FIG. 22 is a drawing for explaining a definition of resolution.

FIG. 23 is a plan view showing a modification of a configuration of the light-emitting element group.

FIG. 24 is a plan view showing another modification of a configuration of the light-emitting element group.

### DESCRIPTION OF EXEMPLARY EMBODIMENTS

### A. First Embodiment

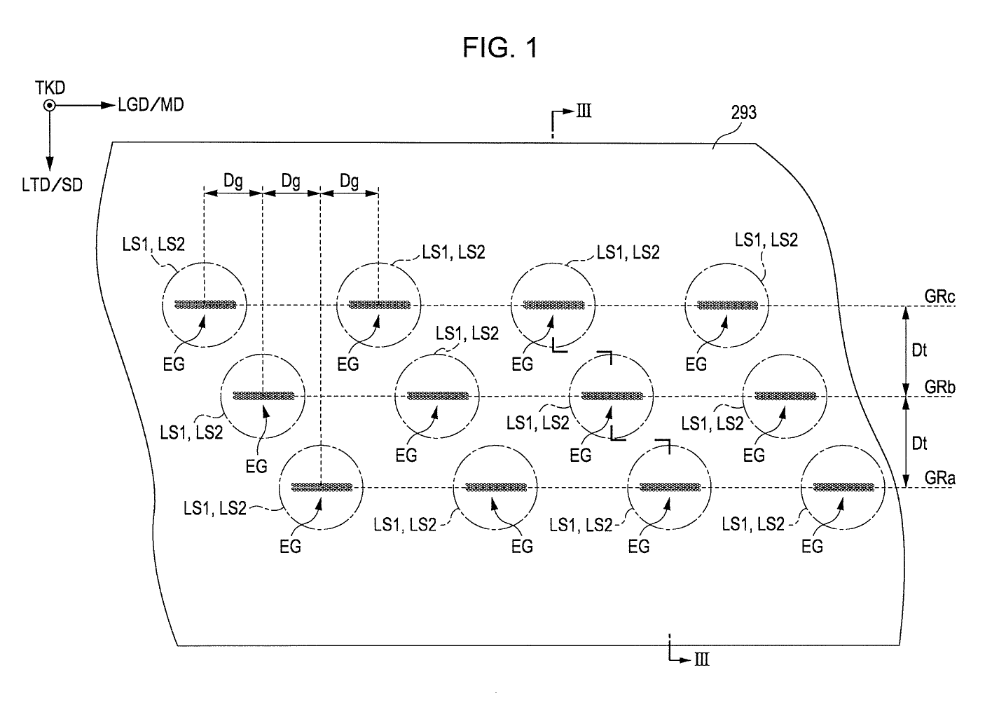

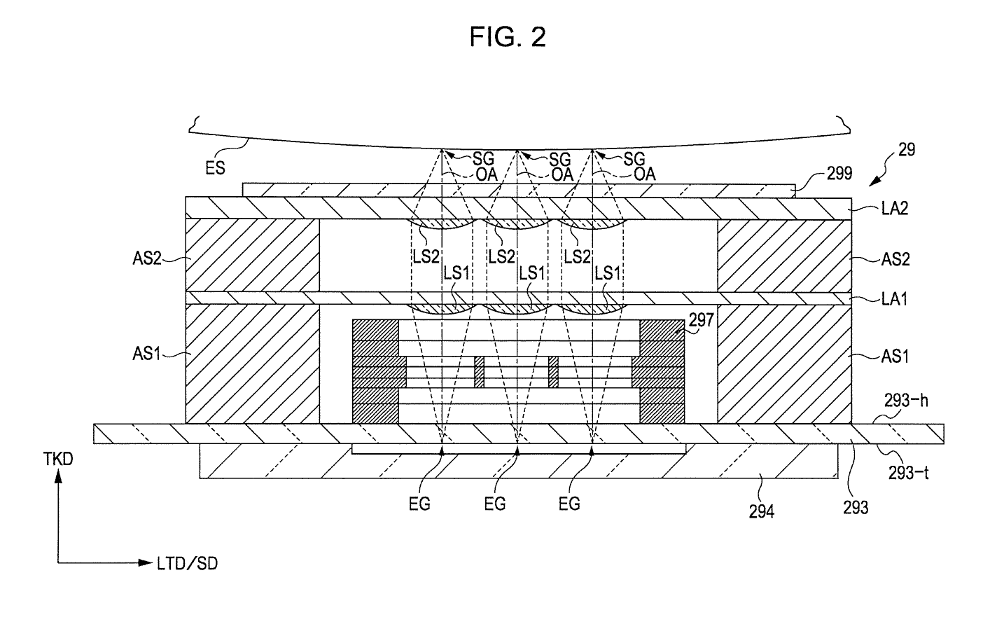

FIG. 1 and FIG. 2 are drawings showing an example of a line head to which the invention can be applied. In particular, FIG. 1 is a plan view of a positional relationship between light-emitting elements and lenses provided on a line head 29 viewed in a thickness direction TKD of the line head 29. FIG. 2 is a partial stepped cross-sectional view of the line head 29 taken along the line III-III (stepped chain double-dashed line in FIG. 1), which corresponds to a case where the cross-section is viewed in a longitudinal direction LGD of the line head 29. The line head 29 is long in the longitudinal direction LGD and short in a width direction LTD, and has a predetermined thickness (height) in the thickness direction TKD. In the drawings shown below including FIG. 1 and FIG. 2, the longitudinal direction LGD, the width direction LTD, and the thickness direction TKD of the line head 29 are shown as needed. These directions LGD, LTD, and TKD are orthogonal or substantially orthogonal to each other. In the following description, the side indicated by an arrow in the thickness direction TKD is expressed as “front” or “up”, and the side opposite from the direction of arrow in the thickness direction TKD is expressed as “back” or “down”.

As described later, when applying the line head 29 to an image forming apparatus, the line head 29 performs exposure with respect to an exposed surface ES (the surface of the photosensitive drum) moving in a secondary scanning direction SD, which is orthogonal or substantially orthogonal to a primary scanning direction MD. In addition, the primary scanning direction MD of the exposed surface ES is parallel to or substantially parallel to the longitudinal direction LGD of the line head 29 and the secondary scanning direction SD of the exposed surface ES is parallel to or substantially parallel to the width direction LTD of the line head 29. Therefore, the primary scanning direction MD and the secondary scanning direction SD will also be indicated together with the longitudinal direction LGD and the width direction LTD as needed.

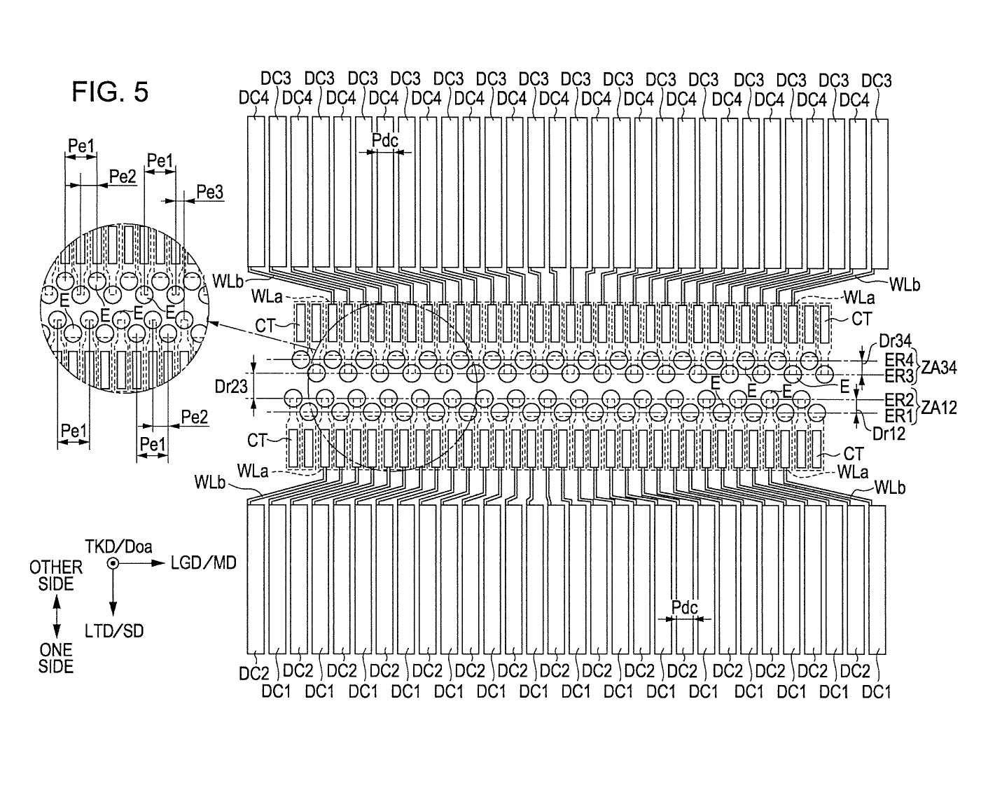

In the line head 29 according to a first embodiment, a plurality of light-emitting elements E are grouped to constitute one light-emitting element group EG (the mode of arrangement of the light-emitting elements E will be described in detail later with reference to FIG. 5), and a plurality of the light-emitting element groups EG are arranged dispersedly in a zigzag pattern (three-row zigzag pattern) (FIG. 1). In this manner, the plurality of light-emitting element groups EG are arranged by being shifted by a distance Dg in the longitudinal direction LGD with respect to each other, and being shifted by a distance Dt in the width direction LTD with respect to each other. In a way, it can be said that light-emitting element group rows GR each including the plurality of light-emitting element groups EG, which are arranged linearly in the longitudinal direction, are arranged in three rows GRa, GRb, and GRc at different positions in the width direction LTD.

The respective light-emitting elements E are bottom-emission type organic EL (Electro-Luminescence) elements having the same light-emitting spectrum. In other words, the organic EL elements which constitute the respective light-emitting elements E are formed on a back surface 293-t of a head substrate 293, which is a glass plate being long in the longitudinal direction LGD and short in the width direction LTD, and are sealed with a glass-made sealing member 294. The sealing member 294 is fixed to the back surface 293-t of the head substrate 293 with an adhesive agent.

One imaging optical system opposes each of the plurality of light-emitting element groups EG. The imaging optical system includes two lenses LS1 and LS2 being convex toward the light-emitting element groups EG. In FIG. 1, the lenses LS1 and LS2 are shown by chain line circles. However, they are intended to show the positional relationship between the light-emitting element groups EG and the lenses LS1 and LS2 in plan view in the thickness direction TKD, and are not intended to show that the lenses LS1 and LS2 are formed directly on the head substrate 293. In FIG. 2, a member 297 is illustrated between the light-emitting element groups EG and the imaging optical systems LS1 and LS2. This will be described after the description of the imaging optical system.

In the line head 29, in order to arrange the lenses LS1 and LS2 so as to oppose the plurality of light-emitting element groups EG arranged in three-row zigzag pattern respectively, a lens array LA1 having a plurality of the lenses LS1 arranged in three-row zigzag pattern and a lens array LA2 having a plurality of the lenses LS2 arranged in three-row zigzag pattern are provided. In other words, in the lens array LA1 (LA2), the plurality of lenses LS1 (LS2) are arranged so as to be shifted by the distance Dg in the longitudinal direction LGD and are shifted by the distance Dt in the width direction LTD, respectively.

The lens array LA1 (LA2) can be obtained by forming the resin lenses LS1 (LS2) on a light-transmissive glass plate. In this embodiment, considering the fact that it is difficult to manufacture the lens array LA1 (LA2) elongated in the longitudinal direction LGD in an integral configuration, the resin lenses LS1 (LS2) are arranged in three-row zigzag pattern on the relatively short glass plate to manufacture a single short lens array, and a plurality of the short lens arrays are arranged in the longitudinal direction LGD, thereby forming the lens array LA1 (LA2) elongated in the longitudinal direction LGD.

More specifically, spacers AS1 are arranged on a front surface 293-h of the head substrate 293 at both ends thereof in the width direction LTD and the plurality of short lens arrays arranged so as to extend between the spacers AS1 and AS1 in the longitudinal direction LG, so that the single lens array LA1 is formed. Spacers AS2 are arranged on the surface of the lens array LA1 on both sides thereof in the width direction LTD and the plurality of short lens arrays are arranged so as to extend between the spacers AS2 and AS2 in the longitudinal direction LGD, so that the single lens array LA2 is formed. In addition, a flat-panel-shaped supporting glass 299 is bonded to the surface of the lens array LA2, so that the respective short lens arrays which constitute the lens array LA2 are supported not only by the spacers AS2, but also by the supporting glass 299 from the opposite side from the spacers AS2. The supporting glass 299 also has a function to cover the lens array LA2 so that the lens array LA2 is not exposed to the outside.

In this manner, in the thickness direction TKD, the lens arrays LA1 and LA2 which are arranged at a predetermined distance oppose the head substrate 293. Accordingly, the imaging optical system LS1 and LS2 having optical axes OA parallel to or substantially parallel to the thickness direction TKD oppose the light-emitting element groups EG. Therefore, lights emitted from the respective light-emitting elements E of the light-emitting element group EG transmit the head substrate 293, the imaging optical system LS1 and LS2, and a supporting glass SS in sequence and is directed on the exposed surface ES (broken line in FIG. 2). Accordingly, the lights from the respective light-emitting elements E of the light-emitting element group EG receive an imaging action from the imaging optical system LS1 and LS2 and are directed on the exposed surface ES as spots, so that a spot group SG including a plurality of the spots is formed on the exposed surface ES. The imaging optical system LS1 and LS2 form inverted images (negative in lateral magnification β) and is an inversion and reduction optical system whose absolute value of the lateral magnification β (imaging magnitudes) is smaller than 1.

As is understood from the description shown above, the line head 29 in the first embodiment includes the imaging optical systems LS1 and LS2 specific for the respective plurality of light-emitting element groups EG arranged therein. In the line head 29 in this configuration, lights from the light-emitting element group EG preferably enter only the imaging optical systems provided in the light-emitting element group EG, but do not enter other imaging optical systems. Accordingly, in the first embodiment, the light-shielding member 297 is provided between the front surface 293-h of the head substrate 293 and the lens array LA1.

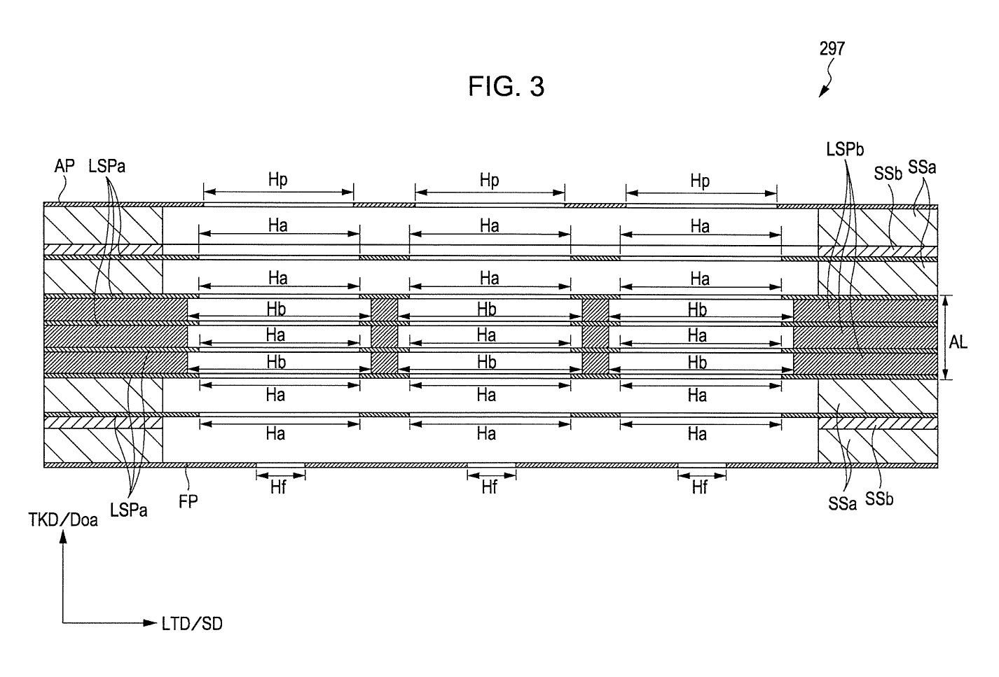

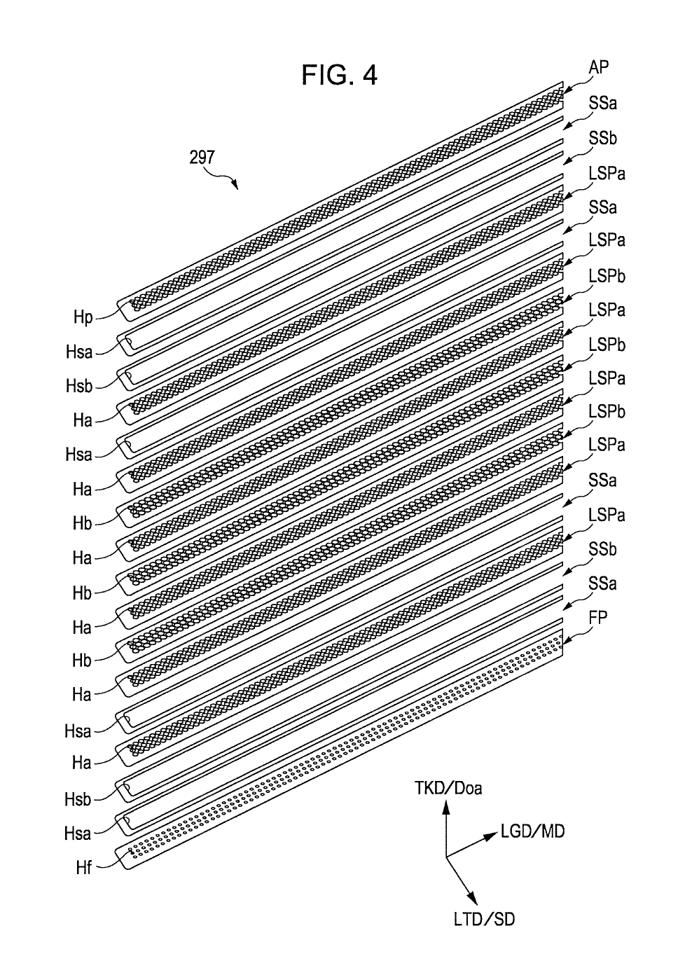

FIG. 3 is a stepped cross-sectional view of the light-shielding member taken along the line III-III, and FIG. 4 is an exploded perspective view of the light-shielding member. In these drawings, a light-traveling direction Doa is set to a direction parallel to the optical axes OS and directed from the light-emitting element group EG to the exposed surface ES (the light-traveling direction Doa extends parallel to or substantially parallel to the thickness direction TKD). As shown in these drawings, the light-shielding member 297 has a configuration including a first light-shielding panel FP, a second light-shielding panel LSPa, a third light-shielding panel LSPb and an aperture panel AP, and a first spacer SSa and a second spacer SSb which define the distance among these panels FP, LSPa, LSPb, and AP. More specifically, these panels and the spacers are laminated and fixed with an adhesive agent in the thickness direction TKD.

The panels FP, LSPa, LSPb, and AP are all have a function to allow passage of part of the lights from the light-emitting element group EG and block passage of other lights therethrough, and includes openings Hf, Ha, Hb, and Hp between the light-emitting element groups EG and the imaging optical systems LS1 and LS2 opposing the same. The openings Hf, Ha, Hb, and Hp are respectively positioned so that the geometrical centers of gravity thereof match or substantially match the optical axes of the imaging optical systems LS1 and LS2. In other words, as shown in FIG. 3 and FIG. 4, circular openings Hf, Ha, Hb, and Hp are arranged in three-row zigzag pattern on the panels FP, LSPa, LSPb, and AP, respectively so as to penetrate therethrough in the thickness direction TKD corresponding to the three-row zigzag pattern of the light-emitting element groups EG. Portions of the lights emitted from the light-emitting element groups EG, which pass through the openings Hf, Ha, Hb, and Hp, enter the imaging optical systems LS1 and LS2, and most of other portions of the lights are blocked by the panels FP, LSPa, LSPb, and AP. The thicknesses of the panels FP, LSPa, LSPb, and AP satisfy the relationship; FP≈AP≈LSPa<LSPb, and the diameter of the respective openings satisfy the following relationship Hf<Hp<Ha<Hb.

The spacers SSa and SSb are frame bodies having substantially rectangular-shaped elongated holes Hsa and Hsb formed so as to penetrate therethrough in the thickness direction TKD. The elongated holes Hsa and Hsb are formed to have dimensions which are large enough to embrace the respective openings Hf, Ha, Hb, and Hp completely therein in plan view of the light-shielding member 297 when seeing therethrough in the thickness direction TKD. Therefore, the lights emitted from the respective light-emitting element groups EG travel through the elongated holes Hsa and Hsb toward the exposed surface ES (FIG. 2).

Subsequently, the mode of arrangement of the light-shielding member 297 will be described more specifically. The first light-shielding panel FP is placed on and fixed to the front surface 293-h (FIG. 2) of the head substrate 293, and the second light-shielding panel LSPa is arranged on the side of the light-traveling direction Doa of the first light-shielding panel FP. Two spacers SSa and SSb are interposed between the first light-shielding panel FP and the second light-shielding panel LSPa. A stray light absorbing layer AL is formed of two types of the panels on the side of the light-traveling direction Doa of the second light-shielding panel LSPa, and the first spacer SSa is interposed between the second light-shielding panel LSPa and the stray light absorbing layer AL. The stray light absorbing layer AL includes two types of the light-shielding panels LSPa and LSPb different in diameter of opening and thickness laminated alternately in the light-traveling direction Doa. More specifically, it includes the four second light-shielding panels LSPa and the three third light-shielding panels LSPb. The second light-shielding panel LSPa and the aperture panel AP are arranged in the light-traveling direction Doa in this order on the side of the light-traveling direction Doa of the stray light absorbing layer AL. The spacer SSa is interposed between the stray light absorbing layer AL and the second light-shielding panel LSPa, and the two spacers SSa and SSb are interposed between the second light-shielding panel LSPa and the aperture panel AP.

With the provision of the light-shielding member 297 in this manner, a plurality of the openings Hf, Ha, Hb, and Hp are arranged in the light-traveling direction Doa between the respective light-emitting element groups EG and the imaging optical systems LS1 and LS2 opposing the same. Consequently, the portions of the lights emitted from the light-emitting element group EG, which pass through the openings Hf, Ha, Hb, and Hp opposing the light-emitting element group EG, reach the imaging optical systems LS1 and LS2, and most of other portions of the lights are blocked by the light-shielding panels FP, LSPa, LSPb, and Ap and hence do not reach the imaging optical systems LS1 and LS2. Accordingly, desirable exposure without being affected by ghost is achieved.

Subsequently, the mode of arrangement of the light-emitting elements E in the light-emitting element group EG will be described. FIG. 5 is a partial plan view showing the mode of arrangement of light-emitting elements in the light-emitting element group. A chain line circle at a left end of the drawing is an excerpt of a range surrounded by a chain line circle shown at the substantially center of the drawing. FIG. 5 shows a configuration of the back surface 293-t of the head substrate 293, and elements shown in this drawing are formed on the back surface 293-t of the head substrate 293. The light-emitting element group EG includes the plurality of (17×4 rows) light-emitting elements E grouped into one. In other words, as shown in the same drawing, the seventeen light-emitting elements E are linearly arranged at a pitch of Pe1 (=60 [μm]) in the longitudinal direction LGD to constitute one light-emitting element row ER. The one light-emitting element group EG includes four light-emitting element rows ER1 to ER4 arranged at different positions in the width direction LTD.

The light-emitting element row ER1 and the light-emitting element row ER2 are shifted from each other by a pitch Pe2 (=Pe1/2) in the longitudinal direction LGD. Consequently, the light-emitting elements E belonging to the light-emitting element row ER1 and the light-emitting elements E belonging to the light-emitting element row ER2 are arranged in a zigzag pattern alternately in the longitudinal direction LGD at the pitch of Pe2. In the same manner, the light-emitting element row ER3 and the light-emitting element row ER4 are shifted from each other by the pitch Pe2 in the longitudinal direction LGD. Consequently, the light-emitting elements E belonging to the light-emitting element row ER3 and the light-emitting elements E belonging to the light-emitting element row ER4 are arranged alternately in the longitudinal direction LGD at the pitch of Pe2. A zigzag arrangement ZA12 including the light-emitting elements E in the light-emitting element rows ER1 and ER2 and a zigzag arrangement ZA34 including the light-emitting elements E in the light-emitting element rows ER3 and ER4 are shifted from each other by a pitch Pe3 (=Pe2/2) in the longitudinal direction LGD. Consequently, the four light-emitting elements E belonging to the light-emitting element rows ER2, ER4, ER1, and ER3 are arranged cyclically in this order in the longitudinal direction LGD at the pitch of Pe3.

Here, for example, the pitch of the light-emitting elements E in the longitudinal direction LGD is obtained as a distance between the geometrical centers of gravity of the two light-emitting elements E and E arranged at the corresponding pitch in the longitudinal direction LGD.

The distances Dr12, Dr34, and Dr23 between the four light-emitting element rows ER1 to ER4 in the light-emitting element group EG in the width direction LTD are as follows. The distance Dr12 between the light-emitting element row ER1 and the light-emitting element row ER2, the distance Dr23 between the light-emitting element row ER2 and the light-emitting element row ER3, and the distance Dr34 between the light-emitting element row ER3 and the light-emitting element row ER4 satisfy ratios of whole numbers. In other words, the following equation; Dr12:Dr23:Dr34=l:m:n (l, m, and n are positive integer numbers) is satisfied. In particular, in the first embodiment, Dr12:Dr23:Dr34=l:m:n=2:3:2 is satisfied.

Here, for example, the distance Dr12 is obtained as a distance between an imaginary line passing through the geometrical centers of gravity of the light-emitting elements E of the light-emitting element row ER1 and extending in parallel to the longitudinal direction LGD and an imaginary line passing through the geometrical centers of gravity of the light-emitting elements E of the light-emitting element row ER2 and extending in parallel to the longitudinal direction LGD in the width direction LTD. The distances Dr23 and Dr34 are obtained in the same manner.

Arranged on one side of the light-emitting element group EG in the width direction LTD are drive circuits DC1 and DC2 that drive the plurality of light-emitting elements E which belong to the light-emitting element rows ER1 and ER2 and constitute the zigzag arrangement ZA12. More specifically, the drive circuits DC1 that drive the light-emitting elements E of the light-emitting element row ER1 and the drive circuits DC2 that drive the light-emitting elements E of the light-emitting element row ER2 are arranged alternately in the longitudinal direction LGD. The drive circuits DC1, DC2, . . . are arranged linearly in the longitudinal direction LGD at a pitch of Pdc (>Pe2). The drive circuits DC1 and DC2 each are formed of a TFT (thin film transistor) and configured to hold a signal value written by a driver IC 295, described later, temporarily (more specifically, to store the voltage value as signal values in the capacity) and supply a drive current according to the corresponding signal value.

Formed between the light-emitting elements E which constitute the zigzag arrangement ZA12 and the drive circuits DC1, DC2, . . . in the width direction LTD are a plurality of contacts CT. The plurality of contacts CT are provided adjacent to the plurality of light-emitting elements E which constitute the zigzag arrangement ZA12 in one-to-one correspondence, and are linearly arranged in the longitudinal direction LGD at the same pitch of Pe2 as the plurality of light-emitting elements E. The respective light-emitting elements E which constitute the zigzag arrangement ZA12 and the contacts CT adjacent to the light-emitting elements E are connected by wirings WLa (broken lines in FIG. 5). As shown in FIG. 5, the wirings WLa which connect the light-emitting elements E of the light-emitting element row ER1 and the contacts CT have a substantially constant width. In contrast, the width of the wirings WLa which connects the light-emitting elements E of the light-emitting element row ER2 and the contacts CT are not constant, and distal end portions on the side of the light-emitting elements E have a narrower width. It is because the wirings WLa are to be extend between the light-emitting elements E of the light-emitting element row ER1 up to the light-emitting elements E of the light-emitting element row ER2.

Then, the contacts CT connected to the light-emitting elements E of the light-emitting element row ER1 and the drive circuits DC1 are connected by wirings WLb. Also, the contacts CT connected to the light-emitting elements E of the light-emitting element row ER2 and the drive circuits DC2 are connected by the wirings WLb. Through these wiring paths, the drive circuits DC1 and DC2 supply a drive current to the corresponding light-emitting elements E. As shown in FIG. 5, the drive circuits DC1 and DC2 are not connected to the light-emitting elements E which are formed two each at both ends in the longitudinal direction LGD from among the plurality of light-emitting elements E which constitute the zigzag arrangement ZA12. In other words, these light-emitting elements E are dummy elements which do not receive supply of the drive current, and hence do not emit lights in fact.

In the same manner, the plurality of drive circuits are arranged in the longitudinal direction LGD at a pitch of Pdc (>Pe2) on the other side of the light-emitting element group EG in the width direction LTD. These drive circuits DC3 and DC4 are provided for driving the plurality of light-emitting elements E which belong to the light-emitting element rows ER3 and ER4 and constitute the zigzag arrangement ZA34. The relationship between the drive circuits DC3 and DC4 and the light-emitting element rows ER3 and ER4 (the zigzag arrangement ZA34) is the same as the relationship between the drive circuits DC1 and DC2 and the light-emitting element rows ER1 and ER2 (the zigzag arrangement ZA12), and hence the description will be omitted.

In this manner, the drive circuits DC1 to DC4 are connected to the light-emitting elements E of the light-emitting element group EG, and the respective light-emitting elements E emit lights upon receipt of supply of the drive current from the drive circuits DC1 to DC4. The current supply by the drive circuits DC1 to DC4 is controlled by the electric configuration of the line head 29.

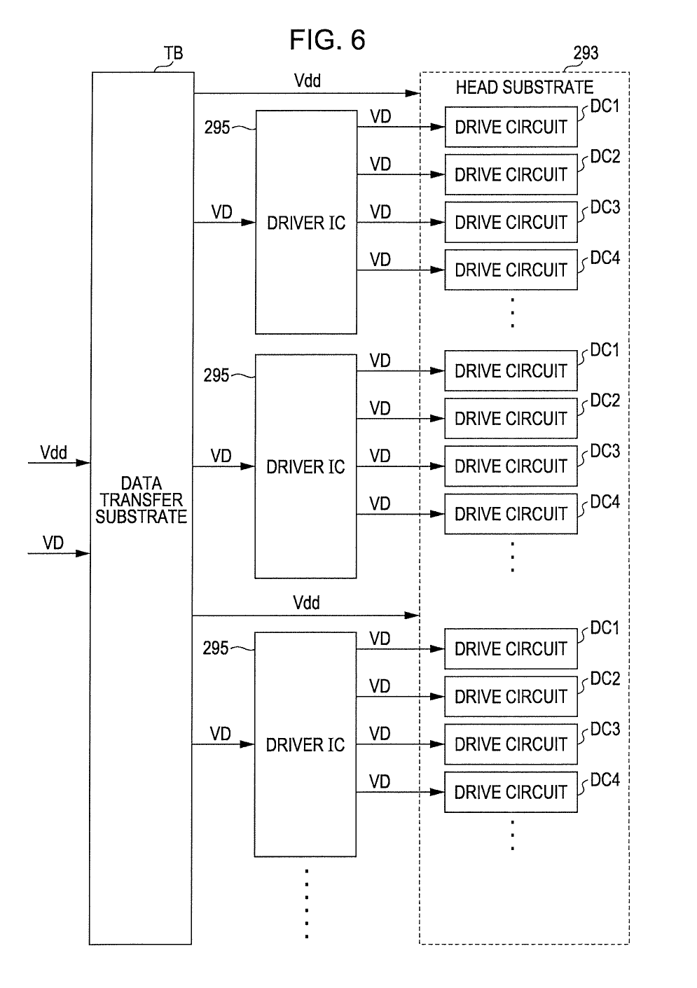

FIG. 6 is a block diagram showing an electric configuration of the line head. As shown in FIG. 6, the electric configuration of the line head 29 includes a data transfer substrate TB and a plurality of the driver ICs 295 in addition to the drive circuits DC1 to DC4. The data transfer substrate TB transfers video data VD received from the outside to the respective driver ICs 295. The respective driver ICs 295 write the video data VD (more specifically, the video data VD converted into voltage values) into the above-described drive circuits DC1 to DC4, and control the light emission of the light-emitting elements E. At this time, the driver ICs 295 may write the video data VD amended according to deteriorations or temperature characteristics of the light-emitting elements E into the drive circuits DC1 to DC4. This writing operation may be performed on the basis of so-called a time-division driving. The data transfer substrate TB also serves to supply a power source Vdd supplied from the outside to (the drive circuits DC1 to DC4 of) the head substrate 293.

The schematic configuration of the line head 29 has been described thus far. As described above, the line head 29 performs exposure of the exposed surface ES by imaging the lights from the light-emitting elements E of the light-emitting element group EG by the imaging optical system which is composed of the lenses LS1 and LS2, and irradiating the exposed surface ES with spots SP of the lights. Therefore, in the description given below, the exposure operation cooperatively performed by the imaging optical system and the light-emitting element group will be described in detail with reference to specific examples of configurations of the imaging optical system and the light-emitting element group. In the description given below, expressions “primary direction” (or “primary direction x) as a direction corresponding to the primary scanning direction MD and “secondary direction” (or “secondary direction y”) as a direction corresponding to the secondary scanning direction SD are used as needed.

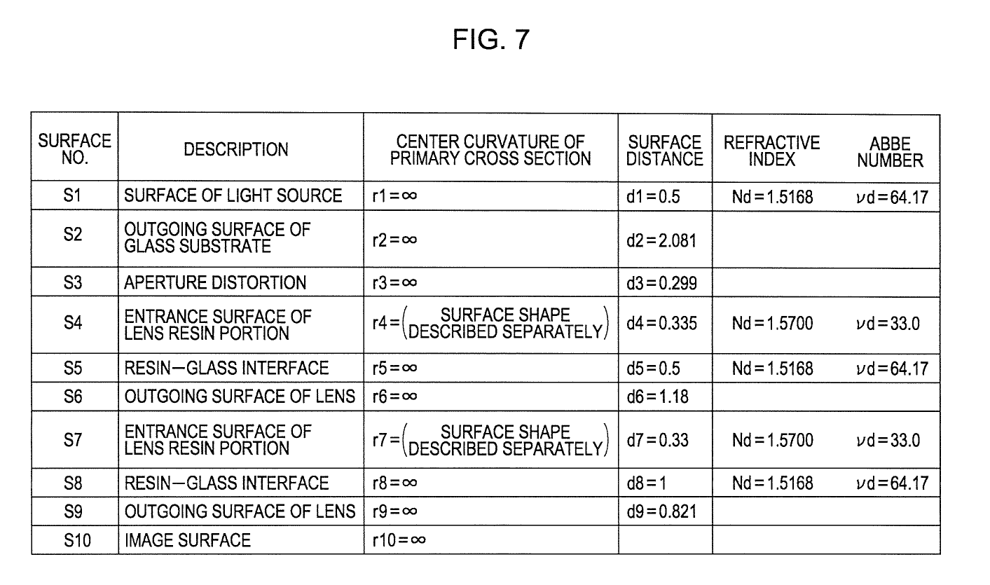

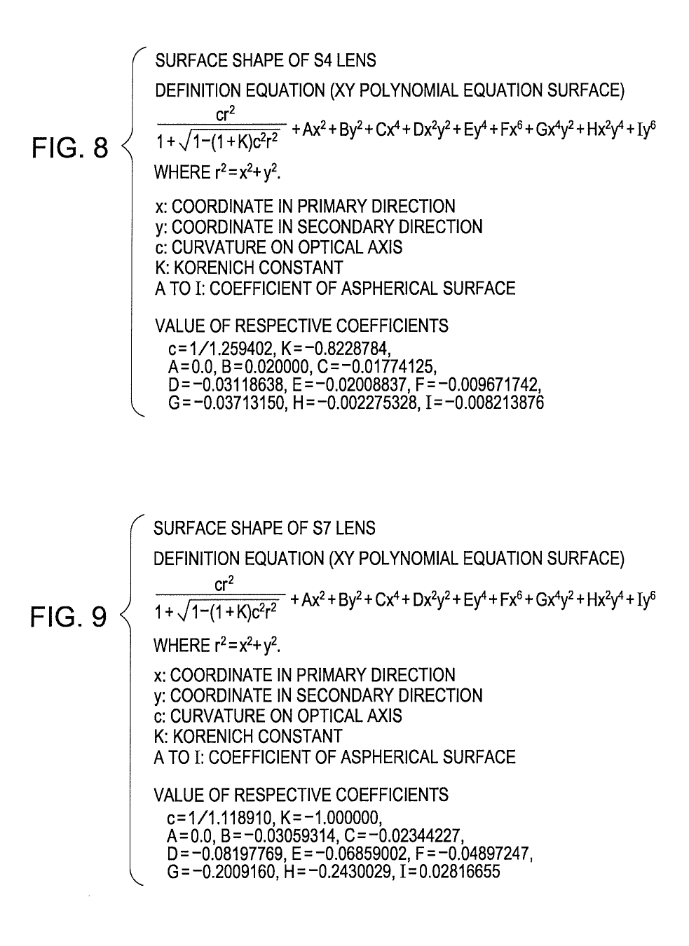

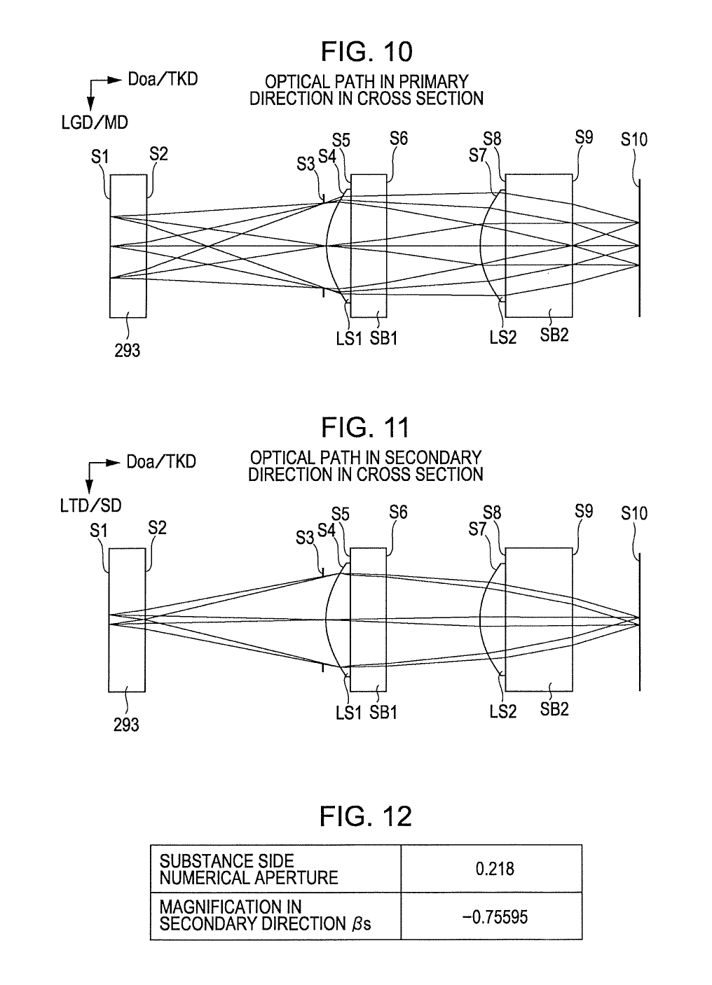

FIGS. 7 to 12 are drawings showing the configuration of the imaging optical system. More specifically, FIG. 7 is a table showing lens data of the imaging optical system. FIG. 8 shows data for providing a surface shape of S4 in FIG. 7. FIG. 9 shows data for providing a surface shape of S7 in FIG. 7. FIG. 10 shows an optical path of the imaging optical system taken along the primary direction. FIG. 11 shows the optical path of the imaging optical system taken along the secondary direction. FIG. 12 is a table showing a substance-side numerical aperture and a magnification in the secondary direction ⊖s (the lateral magnification in the secondary scanning direction SD) of the imaging optical system. According to this table, the substance-side numerical aperture is 0.218, and the magnification in the secondary direction βs is −0.75595.

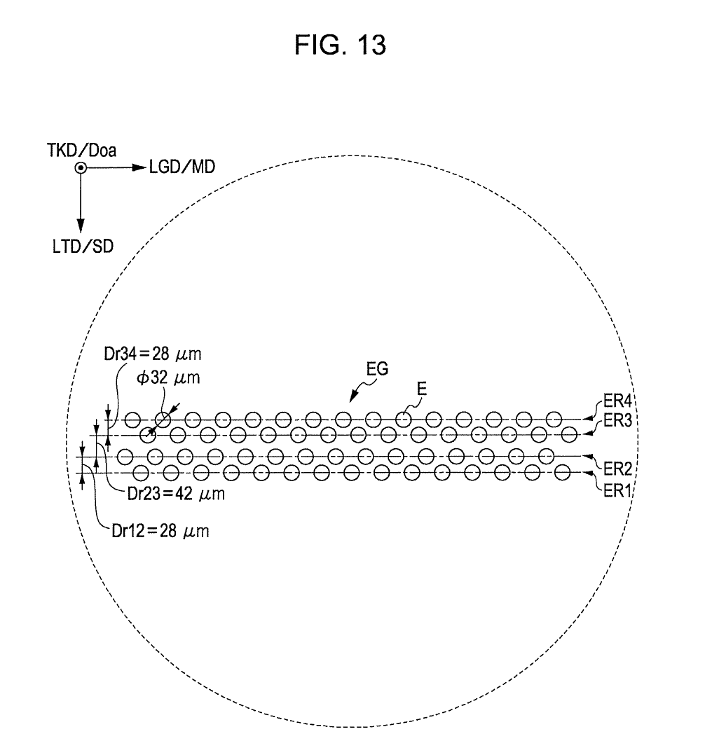

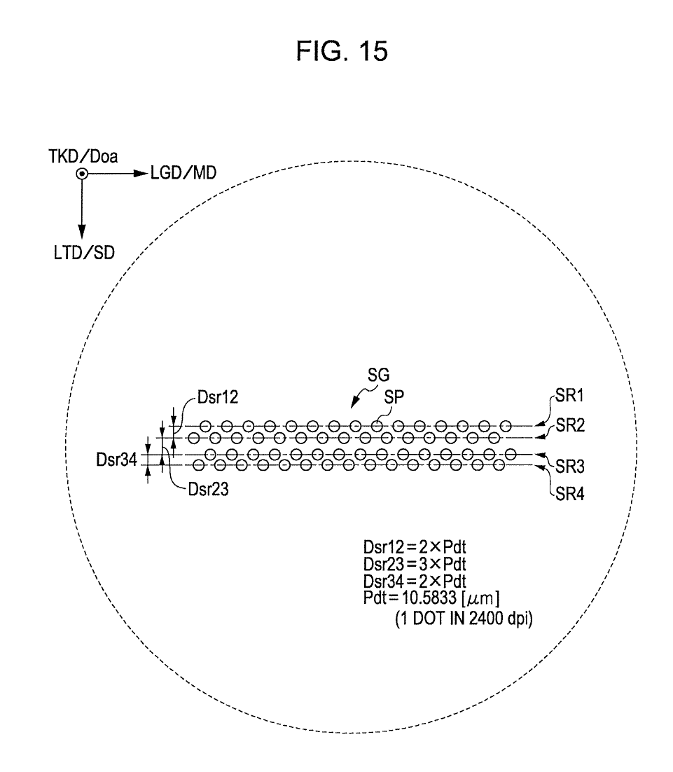

As is understood from FIGS. 7 to 12, a surface S1 is a back surface (a surface on which the organic EL element is formed) of a glass substrate as the head substrate 293, a surface S2 is a front surface of the glass substrate as the head substrate 293, a surface S3 is a aperture stop, the surface S4 is a lens surface of the resin lens LS1, a surface S5 is a boundary between the resin lens LS1 and the back surface of a glass substrate SB1 on which the resin lens LS1 is formed, a surface S6 is a front surface of the glass substrate SB1, the surface S7 is a lens surface of the resin lens LS2, a surface S8 is a boundary between the resin lens LS2 and a glass substrate SB2 on which the resin lens LS2 is formed, a surface S9 is a front surface of the glass substrate SB2, and a surface S10 is an image surface (exposed surface). The lights from the light-emitting element group EG (FIG. 13) are imaged by the imaging optical system configured as describe above, and the spot group SG (FIG. 15) is formed on the exposed surface ES.

FIG. 13 is a plan view showing a configuration of the light-emitting element group. In FIG. 13, only the light-emitting elements E which emit lights in fact and are used for spot formation are illustrated, and the illustration of the dummy elements is omitted. As described above with reference to FIG. 5, the distances Dr12, Dr34, and Dr23 between the four rows of light-emitting element rows ER1 to ER 4 arranged in the secondary scanning direction SD in the light-emitting element group EG satisfy the equation; Dr12:Dr23:Dr34=l:m:n (l, m, and, n are positive integer numbers). In particular, in the first embodiment, Dr12=28 [μm], Dr23=42 [μm], and Dr34=28 [μm], and Dr12:Dr23:Dr34=l:m:n=2:3:2 is satisfied. The diameters of the respective circular light-emitting elements which constitute the light-emitting element group EG are 32 [μm].

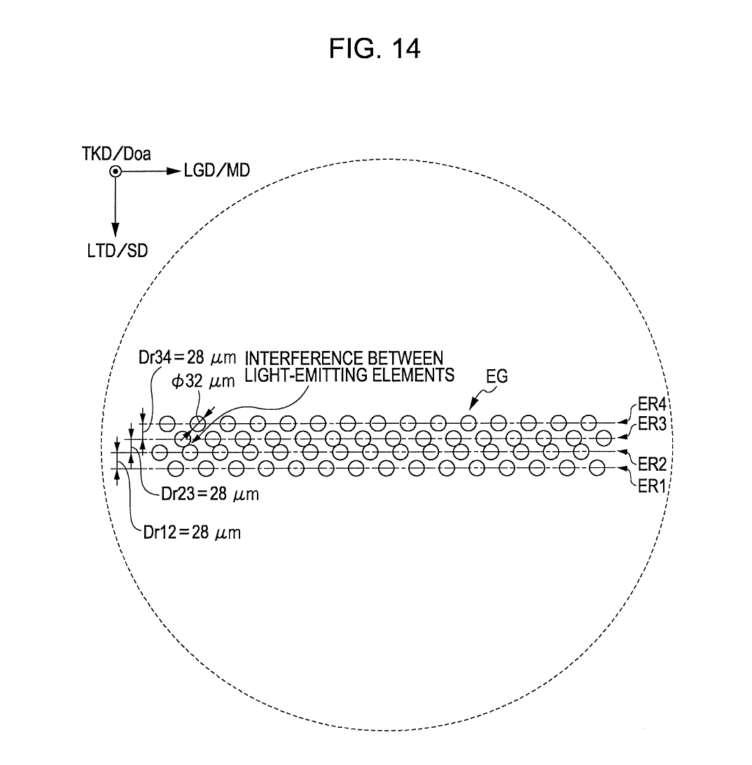

In this embodiment, the distances Dr12, Dr23, and Dr34 are set to satisfy the equation; m=l+1=n+1, and the distance Dr23 is larger than the distances Dr12 and Dr34. It is intended to avoid interference (FIG. 14) between the light-emitting element row ER2 and the light-emitting element row ER3 while maintaining the dimensions of the light-emitting elements E. FIG. 14 is a plan view showing a light-emitting group in which the distances Dr12, Dr34, and Dr23 are equal. In the example shown in FIG. 14, the distances Dr12, Dr34, and Dr23 are all 28 [μm] and are equal to each other, and the distance Dr23 between the light-emitting element row ER2 and the light-emitting element row ER3 are not secured sufficiently. Consequently, interference is occurred between the light-emitting element row ER2 and the light-emitting element row ER3. Therefore, in order to achieve the configuration shown in FIG. 14 in which the distances Dr12, Dr34, and Dr23 are equal, the diameters of the light-emitting elements E are needed to be set to a value smaller than 32 [μm]. However, this is not preferable because the amount of light used for the spot formation is reduced. Therefore, in this embodiment, the distances Dr12, Dr23, and Dr34 are set to satisfy the equation; m=l+1=n+1, and the distance Dr23 is larger than the distances Dr12 and Dr34. Accordingly, the interference between the light-emitting element row ER2 and the light-emitting element row ER3 can be avoided while maintaining the dimensions of the light-emitting elements E and securing the amount of light used for the spot formation sufficiently.

FIG. 15 is a plan view showing a configuration of the spot group formed by illuminating the respective light-emitting elements of the light-emitting element group shown in FIG. 13 simultaneously. As described above, the lateral magnification of the imaging optical system is negative and the absolute value is smaller than 1. Therefore, the spot group SG has substantially such configuration that the light-emitting element group EG is rotated by 180° and is contracted. Consequently, the spot group SG includes the spot row including 15 spots SP arranged in line in the primary scanning direction MD, and four of such spot rows SR 1 to SR 4 are arranged in the secondary scanning direction SD in this order. The spot row SR1 is formed by imaging the lights from the light-emitting element row ER1, and the spot rows SR2, Sr3, and SR4 also have the same relationship with the light-emitting element rows ER2, ER3, and ER4.

The absolute value of the lateral magnification βs of the imaging optical system in the secondary scanning direction SD is 0.75595. Therefore, respective distances Dsr12, Dsr34, and Dsr23 between the four spot rows SR1 to SR4 in the secondary scanning direction SD, that is, the distance Dsr12 between the spot row SR1 and the spot row SR2, the distance Dsr23 between the spot row SR2 and the spot row SR3, and the distance Dsr34 between the spot row SR2 and the spot rows SR4 are;

Dsr12=|βs|×Dr12=0.75595×28 [μm]=21.16 [μm] Expression 1

Dsr23=|βs|×Dr23=0.75595×42 [μm]=31.75 [μm] Expression 2

Dsr34=|βs|×Dr34=0.75595×28 [μm]=21.16 [μm] Expression 3,

in other words,

Dsr12=l×Pdt=2×Pdt Expression 4

Dsr23=m×Pdt=3×Pdt Expression 5 and

Dsr34=n×Pdt=2×Pdt Expression 6

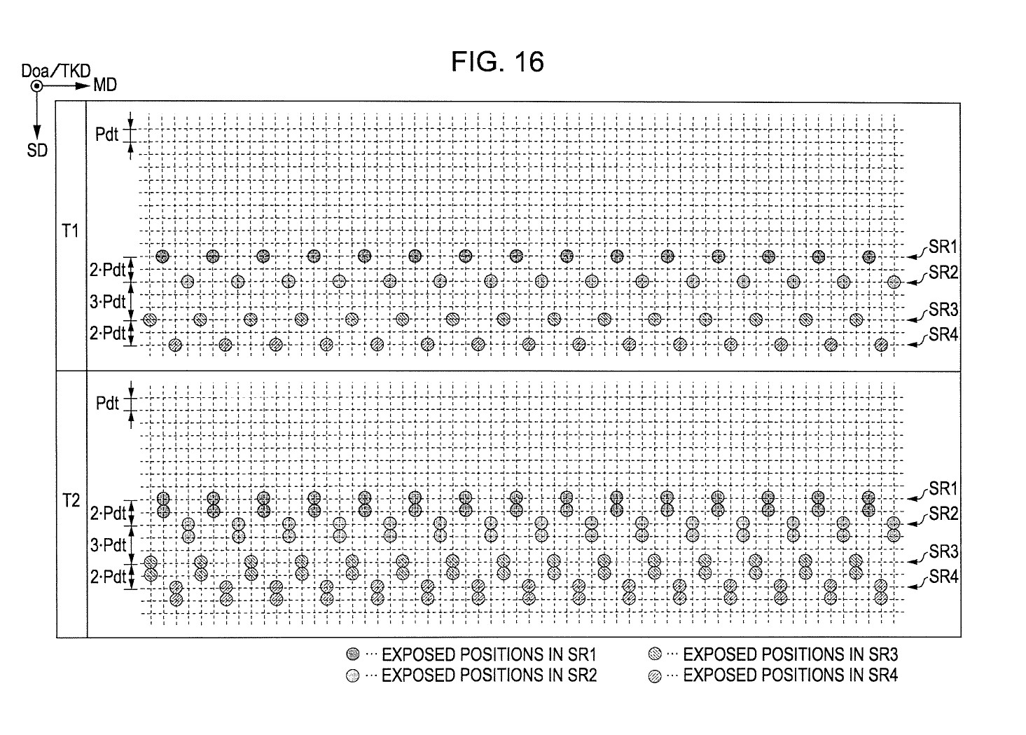

are satisfied. Here, Pdt is found to be 10.5833 [μm], which corresponds to one dot (one pixel) in a resolution 2400 dpi (dot per inch). Therefore, in this example, by repeating the operation to form the four spot rows SR1 to SR4 simultaneously while moving the exposed surface ES (the surface of the photosensitive drum or the like) in the secondary scanning direction SD in sequence, the exposure at the resolution of 2400 dpi is achieved (FIGS. 16 to 19).

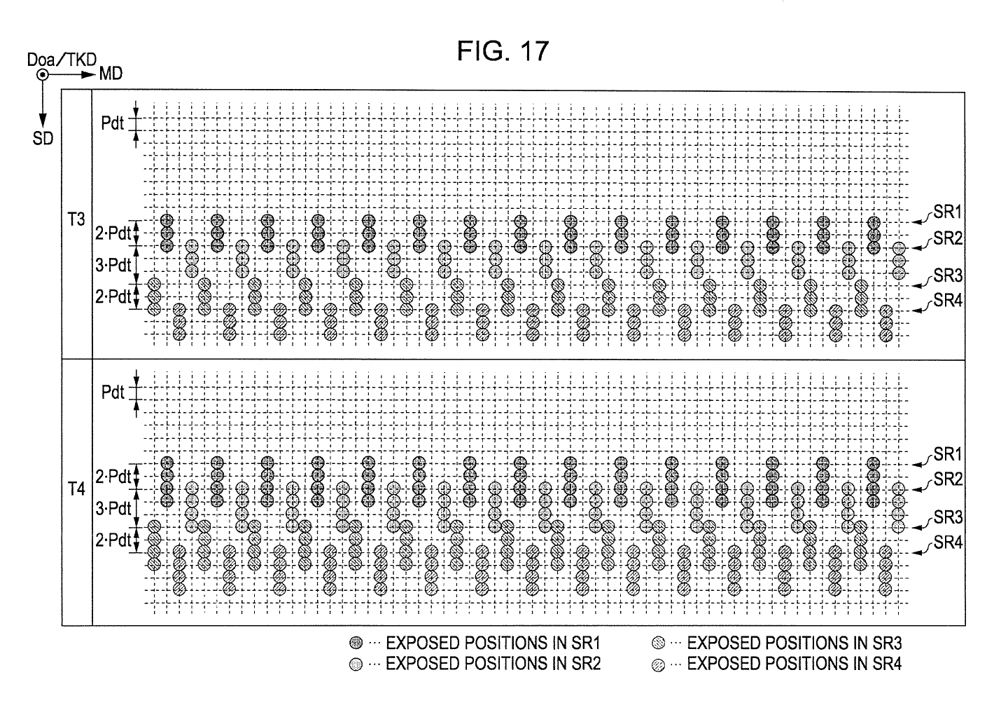

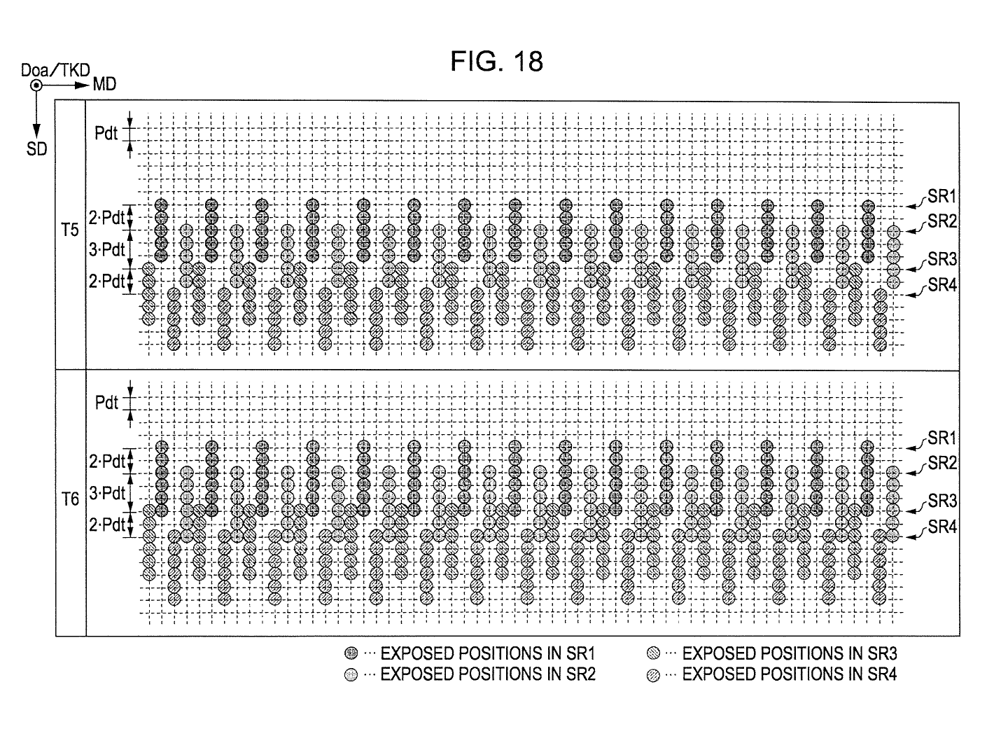

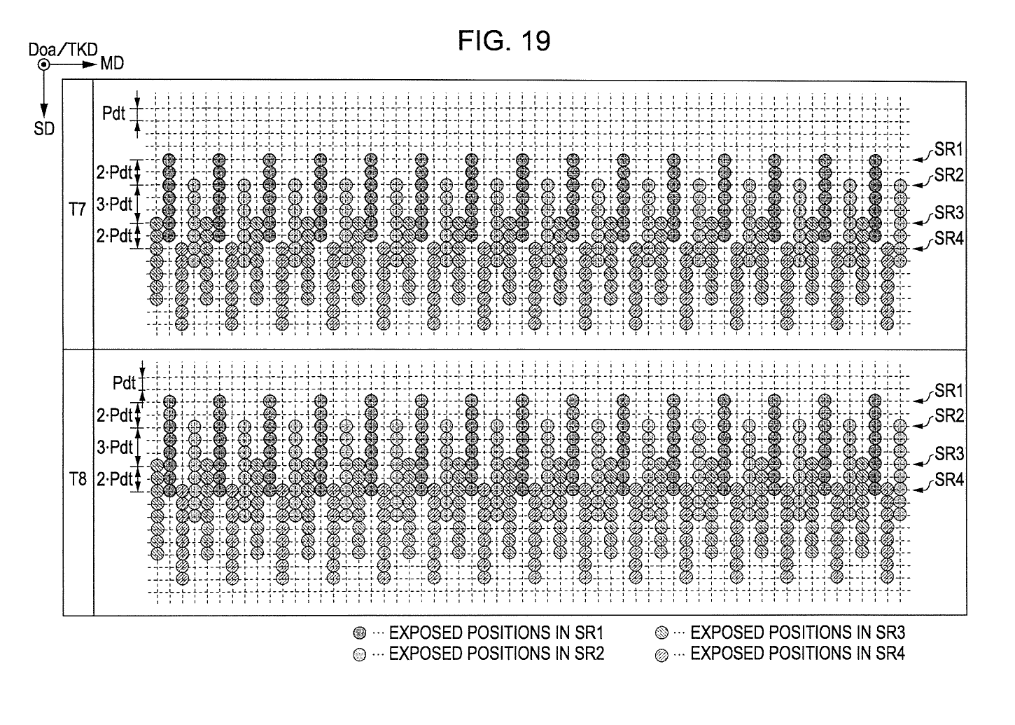

FIG. 16 is a drawing showing the exposure operation at timings T1 and T2. FIG. 17 is a drawing showing the exposure operation at timings T3 ad T4, FIG. 18 is a drawing showing the exposure operation at timings T5 and T6, and FIG. 19 is a drawing showing the exposure operation at timings T7 and T8. In the respective drawings, intersections of a grid indicated by vertical and lateral dotted lines correspond to the center (geometrical centers of gravity) of pixels (dots). The timings T1 to T8 are light-emitting timings provided at regular intervals of ΔT. At the respective timings, the four light-emitting element rows ER1 to ER4 are illuminated simultaneously, and the four spot rows SR1 to SR4 are formed simultaneously. More specifically, the timing interval ΔT is obtained as time period required for the exposed surface ES to move by the distance Pdt, which corresponds to 1 pixel, in the secondary scanning direction SD. Furthermore, the respective drawings show the spot rows formed at the respective timings with reference signs SR1 to SR4, and the distances (2·Pdt, 3·Pdt, 2·Pdt), which are distances between the spot rows SR1 to SR4.

As shown in FIG. 16, at the timing T1, if the four light-emitting element rows ER1 to ER4 are illuminated simultaneously, the four spot rows SR1 to SR4 are formed simultaneously on the exposed surface ES. At this time, since Dsr12=1×Pdt=2×Pdt, Dsr23=m×Pdt=3×Pdt, Dsr34=n×Pdt=2×Pdt (that is, Dsr12, Dsr23 and Dsr34 are l, m, n (integer numbers) times the value of Pdt) are satisfied, respective spots of the four spot rows SR1 to SR4 are formed on the pixels. In this manner, the pixels on which the spots are formed are exposed.

Subsequently, at the timing T2 when the exposed surface ES is moved by the distance Pdt in the secondary scanning direction SD, if the four light-emitting element rows ER1 to ER4 are eliminated simultaneously, the four spot rows SR1 to SR4 are formed simultaneously. In this case as well, Dsr12, Dsr23 and Dsr34 are l, m, n (integer numbers) times the value of Pdt, the four spot rows SR1 to SR4 are formed on the pixels. In addition, at this time, the spot rows SR1 to SR4 are newly formed on respective pixels adjacent to the pixels which are already exposed by the spot rows SR1 to SR4 at the timing T1 on the downstream side in the secondary scanning direction SD. In the same manner, by causing the four light-emitting element rows ER1 to ER4 to illuminate simultaneously at the respective timings T3, . . . T8, . . . , the spots are formed on the respective pixels on the exposed surface ES, so that the entire exposed surface ES can be exposed. The light-emitting timing control as described above is performed by the cooperation of the data transfer substrate TB, the driver IC 295, and the drive circuits DC1 to DC4.

As described thus far, in the first embodiment, the distances Dr12, Dr34, and Dr23 between the four light-emitting element rows ER1 to ER4 arranged in the secondary scanning direction SD has a relationship;

DR12:Dr23:Dr34=l:m:n (l≠m),

where,

l: positive integer number

m: positive integer number

n: positive integer number.

Therefore, the light-emitting timing control such that the respective light-emitting elements E of the four light-emitting element rows ER1 to ER4 are caused to emit lights at the common timing can be applied, so that the light-emitting timing control is simplified.

The integer number 1 and the integer number m have a relation; m=l+1=n+1, and the distance Dr23 is set to be larger than the distances Dr12 and Dr34. Consequently, the dimensions of the respective light-emitting elements E of the light-emitting element rows ER1 to ER4 is increased (φ32 [μm]) so that the amount of light to be used for the spot formation can be easily secured.

In the embodiment shown above, the light-emitting element rows ER1 to ER4 are arranged so as to satisfy the equations 1 to 6 (that is, so as to satisfy Dr12=1×Pdt/|βs|, DR23=m×Pdt/|βs|, and Dr34=n×Pdt/|βs|). Accordingly, the respective light-emitting elements of the four light-emitting element rows ER1 to ER4 are caused to emit lights at the common timing to irradiate the pixels of the exposed surface ES with spots, so that the light-emitting timing control is simplified.

### B. Second Embodiment

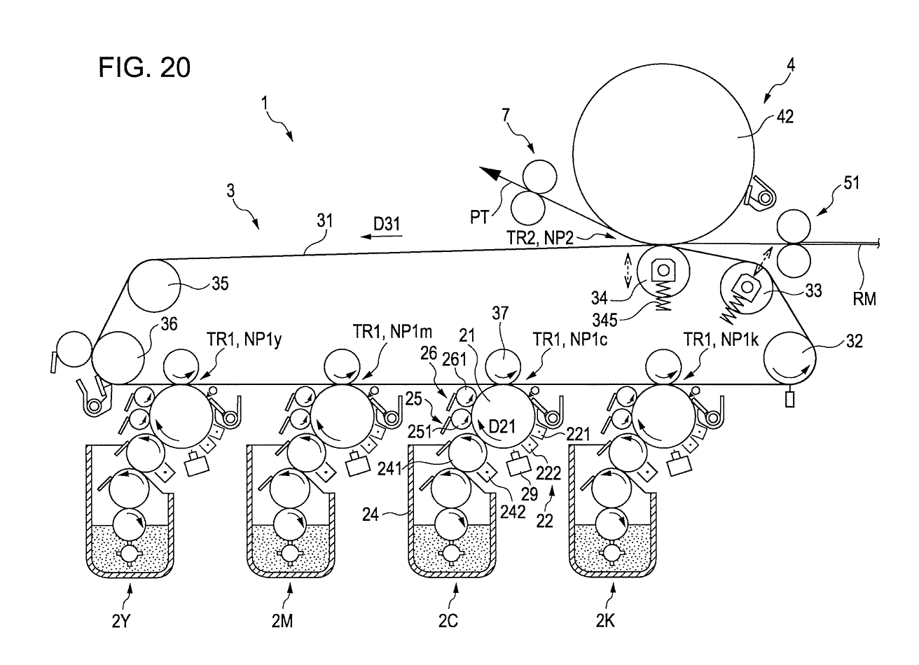

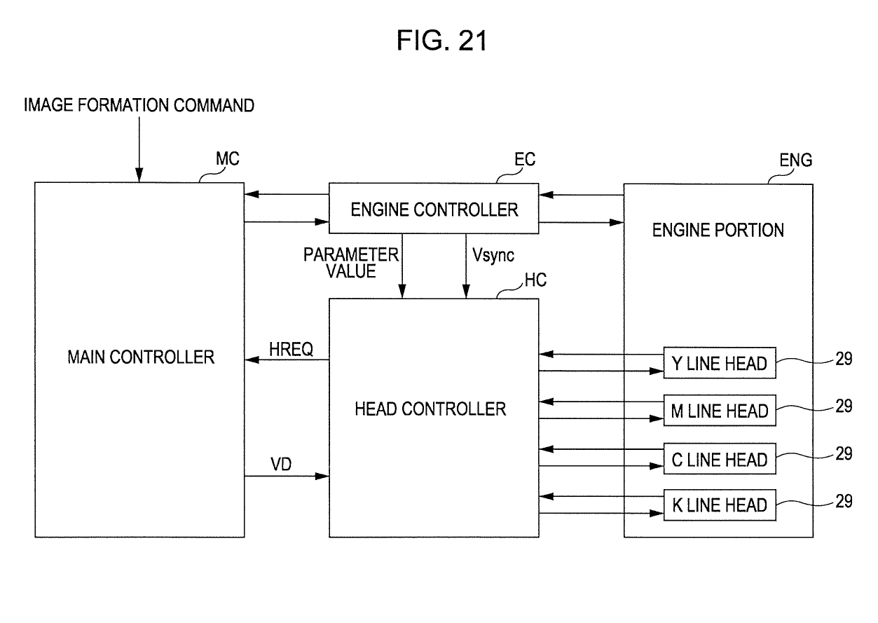

FIG. 20 is a drawing showing an example of an image forming apparatus to which the line head described above can be applied. FIG. 21 is a block diagram showing an electric configuration of the apparatus shown in FIG. 20. In the second embodiment, an example of the image forming apparatus provided with the above-described line head 29 will be described with reference to these drawings. An image forming apparatus 1 includes four image forming stations 2Y (for yellow), 2M (for magenta), 2C (for cyan), and 2K (for black) which form a plurality of images in different colors. Then, the image forming apparatus 1 is capable of being selectively operated in a color mode in which four colors of toner of yellow (Y), magenta (M), cyan (C), and black (K), are overlapped to form a color image and in a monochrome mode in which only black (K) toner is used to form a monochrome image.

In the image forming apparatus, when an image formation command is given from an external apparatus such as a host computer to a main controller MC having a CPU or a memory, the main controller MC provides control signals to an engine controller EC and the video data VD corresponding to the image formation command to a head controller HC. At this time, the main controller MC provides the video data VD corresponding to one line in the primary scanning direction MD to the head controller HC every time upon receipt of a horizontal request signal HREQ from the head controller HC. The head controller HC controls the line heads 29 in respective colors at image forming stations 2Y, 2M, 2C, and 2K on the basis of the video data VD from the main controller MC and a vertical synchronous signal Vsync and a parameter value from the engine controller EC. Accordingly, an engine unit ENG performs a predetermined image forming action, and forms an image corresponding to the image formation command on a sheet-type recording medium RM such as copying paper, transfer paper, paper, or OHP transparent paper.

The respective image forming stations 2Y, 2M, 2C, and 2K have the same structure and functions except for the toner color. Therefore, in FIG. 20, only the components which constitute the image forming station 2C are designated by reference numerals, and reference numerals to be assigned to the remaining image forming stations 2Y, 2M, and 2K are not shown for easy understanding of the drawing. In the following description, the structure and the operation of the image forming station 2C will be described with reference to the reference numerals shown in FIG. 20. However, the structure and the operation of the remaining image forming stations 2Y, 2M, and 2K are the same except for the difference in toner color.

The respective image forming station 2C is provided with a photosensitive drum 21 on which a toner image in cyan is formed on the surfaces thereof. The respective photosensitive drum 21 is arranged in such a manner that axis of rotation thereof is arranged in parallel to or substantially parallel to the primary scanning direction MD (the direction vertical to a paper plane of FIG. 20), and is driven to rotate at a predetermined velocity in a direction indicted by an arrow D21 in FIG. 20. Accordingly, the surface of the photosensitive drum 21 is moved in the secondary scanning direction SD which is orthogonal or substantially orthogonal to the primary scanning direction MD.

Around the each photosensitive drum 21, a charger 22 as a corona charger configured to charge the surface of the photosensitive drum 21 to a predetermined potential, the line head 29 configured to expose the surface of the photosensitive drum 21 according to an image signal to form an electrostatic latent image, a developer 24 configured to visualize the electrostatic latent image as a toner image, a first squeezing portion 25, a second squeezing portion 26, and a cleaning unit configured to perform cleaning of the surface of the photosensitive drum 21 after the transfer are disposed in this order along the direction of rotation D21 of the photosensitive drum 21 (clockwise in FIG. 20).

In this embodiment, the charger 22 includes two corona chargers 221 and 222. The corona charger 221 is arranged on the upstream side of the corona charger 222 in the direction of rotation D21 of the photosensitive drum 21, so that charging is performed in two steps by the two corona chargers 221 and 222. The respective corona chargers 221 and 222 have the same configuration and do not come into contact with the surface of the photosensitive drum 21, and are scorotron chargers.

Then, the line head 29 forms the electrostatic latent image on the basis of the video data VD on the surface of the photosensitive drum 21 charged by the corona chargers 221 and 222. In other words, when the head controller HC sends the video data VD to the data transfer substrate TB (FIG. 6) of the line head 29, the data transfer substrate TB transfer the video data VD to the respective driver ICs 295 and the driver ICs 295 cause the respective light-emitting elements E to emit lights on the basis of the video data VD. At this time, the light-emitting elements E emit lights in the same manner as the descriptions in conjunction with FIG. 16 to FIG. 19. In other words, the light-emitting elements E of the line head 29 emit lights at the timing T1 or the like according to the movement of the surface of the photosensitive drum 21 in the secondary scanning direction SD and the spots are formed on the pixels on the surface of the photosensitive drum 21. Accordingly, the surface of the photosensitive drum 21 is exposed and the electrostatic latent image corresponding to the image signal is formed.

At this time, it is recommended to generate the horizontal request signals HREQ in the head controller HC at every ΔT, which is time period required for the surface of the photosensitive drum 21 to move by the distance Pdt corresponding to one pixel in the secondary scanning direction SD in sequence, and generate the light-emitting timing T1 or the like synchronously with the horizontal request signal HREQ. Accordingly, the spots can be formed on the pixels on the surface of the photosensitive drum 21 by causing the light-emitting element rows ER1 to ER4 of the light-emitting element group EG to emit lights simultaneously at the timing T1 or the like.

The toner is supplied from the developer 24 to the electrostatic latent image formed in this manner, and the electrostatic latent image is developed by the toner. The developer 24 of the image forming apparatus 1 includes a developing roller 241. The developing roller 241 is a cylindrical member, and is provided with a resilient layer such as polyurethane rubber, silicon rubber, NBR, or PFA tube on the outer peripheral portion of an inner core formed of metal such as iron. The developing roller 241 is connected to a developer motor, and rotates with the photosensitive drum 21 by being driven to rotate counterclockwise on the paper plane of FIG. 20. The developing roller 241 is electrically connected to a developing bias generator (constant-voltage power source), not shown, and is configured to be applied with a developing bias at suitable timings.

An anilox roller is provided for supplying liquid developer to the developing roller 241, and liquid developer is supplied from a developer storage unit to the developing roller 241 via the anilox roller. In this manner, the anilox roller has a function to supply the liquid developer to the developing roller 241. The anilox roller is a roller having a depression pattern such as a helical groove curved finely and uniformly on the surface for allowing the liquid developer to be carried easily. In the same manner as the developing roller 241, a roller having a rubber layer such as urethane or NBR wrapped around the metallic core, or having a PFA tube covered thereon is used. The anilox roller rotates by being connected to the developer motor.

As the liquid developer to be stored in the developer storage unit, instead of low concentration (1 to 2 wt %) and low viscosity volatile liquid developer having volatility at room temperatures and containing Isoper (Trade Mark: Exxson) as liquid carrier generally used in the related art, a high viscosity (on the order of 30 to 10000 mPa·s) liquid developer obtained by adding solid material of about 1 μm in average particle diameter including a coloring agent such as pigment dispersed therein to a high concentration and high viscosity resin having non-volatility at room temperatures into a liquid solvent such as organic solvent, silicon oil, mineral oil, or edible oil together with a dispersing agent to have a toner solid content concentration of about 20% is used.

The developing roller 241 having received supply of the liquid developer in this manner rotates synchronously with the anilox roller, and rotates so as to move in the same direction as the surface of the photosensitive drum 21, thereby transporting the liquid developer carried on the surface of the developing roller 241 to the developing position. In order to form the toner image, the developing roller 241 needs to rotate so that the surface thereof moves in the same direction as the surface of the photosensitive drum 21. However, it may be rotated either in the reverse direction or the same direction with respect to the anilox roller.

In the developer 24, a toner-compaction corona generator 242 is arranged so as to oppose the developing roller 241 immediately on the upstream side of the developing position in the direction of rotation of the developing roller 241. The toner-compaction corona generator 242 is electric field applying means configured to increase a charging bias on the surface of the developing roller 241 and is electrically connected to a toner charge generator (not shown) composed of a constant current power source. When a toner charging bias is applied to the toner-compaction corona generator 242, an electric field is applied to the toner as the liquid developer transported by the developing roller 241 at a position near the toner-compaction corona generator 242, so that the toner is charged and compacted. A compaction roller configured to charge by coming into contact may be used instead of the corona discharge on the basis of the application of the electric field for the toner charging and compaction.

The developer 24 configured in this manner is capable of reciprocating between the developing position where the latent image on the photosensitive drum 21 is developed and the retracted position where it is retracted from the photosensitive drum 21. Therefore, while the developer 24 is moved to the retracted position and settled, the supply of new liquid developer to the photosensitive drum 21 is stopped in the image forming station 2C for cyan.

The first squeezing portion 25 is arranged on the downstream side of the developing position in the direction of rotation D21 of the photosensitive drum 21, and the second squeezing portion 26 is arranged on the downstream side of the first squeezing portion 25. Squeezing rollers 251 and 261 are provided at these squeezing portions 25 and 26 respectively. The squeezing roller 251 rotates while receiving a rotary drive force from a main motor in a state of being in abutment with the surface of the photosensitive drum 21 at a first squeeze position, thereby removing excessive developer of the toner image. The squeezing roller 261 rotates while receiving the rotary drive force from the main motor in a state of being abutment with the surface of the photosensitive drum 21 at a second squeeze position on the downstream side of the first squeeze position in the direction of rotation D21 of the photosensitive drum 21, thereby removing excessive liquid carrier or fogged toner of the toner image. In this embodiment, in order to enhance the squeezing efficiency, a squeezing bias generating unit (constant-voltage power source), not shown, is electrically connected to the squeezing rollers 251 and 261, so that a squeezing bias is applied at suitable timings. Although two squeezing portions 25 and 26 are provided in this embodiment, the number and arrangement of the squeezing portions are not limited thereto and, for example, arrangement of only one squeezing portion is also applicable.

The toner image having passed through the squeezing positions is primarily transferred to an intermediate transfer member 31 of a transfer unit 3. The intermediate transfer member 31 is an endless belt as an image carrier which is capable of carrying a toner image temporarily on the surface thereof, more specifically, on the outer peripheral surface thereof, and is wound around a plurality of rollers 32, 33, 34, 35, and 36. The roller 32 is connected to the main motor, and functions as a belt drive roller which circulates the intermediate transfer member 31 in the direction indicated by an arrow D31 in FIG. 20. In this embodiment, in order to enhance the adhesiveness with respect to the recording medium RM and hence enhance the transfer properties of the toner image to the recording medium RM, an resilient layer is provided on the surface of the intermediate transfer member 31 so that the toner image is carried on the surface of the resilient layer.

Here, only the belt drive roller 32 is driven by the main motor from among the rollers 32 to 36 on which the intermediate transfer member 31 is wound, and other rollers 33 to 36 are driven rollers having no driving source. The belt drive roller 32 is wrapped by the intermediate transfer member 31 on the downstream side of a primary transfer position TR1 and on the upstream side of a secondary transfer position TR2, described later, in the direction of belt movement D31.

The transfer unit 3 includes a primary transfer backup roller 37, and the primary transfer backup roller 37 is disposed so as to oppose the photosensitive drum 21 with the intermediary of the intermediate transfer member 31. The outer peripheral surface of the photosensitive drum 21 comes into abutment with the intermediate transfer member 31 at the primary transfer position TR1 where the photosensitive drum 21 and the intermediate transfer member 31 come into abutment with each other to form a primary transfer nip portion NP1c. Then, the toner image on the photosensitive drum 21 is transferred to the outer peripheral surface (the lower surface at the primary transfer position TR1) of the intermediate transfer member 31. The toner image in cyan formed by the image forming station 2C is transferred to the intermediate transfer member 31. In the same manner, the transfer of the toner image is performed at the image forming stations 2Y, 2M and 2K as well, the toner images in respective colors are superimposed on the intermediate transfer member 31 in sequence, and a full color toner image is formed. In contrast, when forming a monochrome toner image, the transfer of the toner image to the intermediate transfer member 31 is performed only at the image forming station 2K corresponding to black color.

The toner image transferred to the intermediate transfer member 31 in this manner is transported to the secondary transfer position TR2 via a position wound around the belt drive roller 32. At the secondary transfer position TR2, a secondary transfer roller 42 of a secondary transfer unit 4 is positioned so as to oppose the roller 34 wrapped by the intermediate transfer member 31 with the intermediary of the intermediate transfer member 31, and the surface of the intermediate transfer member 31 and the surface of the secondary transfer roller 42 come into abutment with each other to form a secondary transfer nip portion NP2. In other words, the roller 34 functions as a secondary transfer backup roller. The rotating shaft of the backup roller 34 is supported by a pressing unit 345 which is a resilient member such as a spring resiliently so as to be capable of moving toward and away from the intermediate transfer member 31.

At the secondary transfer position TR2, a single color or a plurality of colors of toner images formed on intermediate transfer member 31 is transferred to the recording medium RM transported from a pair of gate rollers 51 along a transporting path PT. The recording medium RM on which the toner image is secondarily transferred is fed from the secondary transfer roller 42 to a fixing unit 7 provided on the transporting path PT. In the fixing unit 7, fixation of the toner image to the recording medium RM is performed by applying heat or pressure to the toner image transferred to the recording medium RM. In this manner, a desired image can be formed on the recording medium RM.

As described above, in the second embodiment as well, the distances Dr12, Dr34, and Dr23 between the four light-emitting element rows ER1 to ER 4 arranged in the secondary scanning direction SD satisfy the equation; Dr12:Dr23:Dr34 =l:m:n (l, m, and n are positive integer numbers). Therefore, the light-emitting timing control such that the respective light-emitting elements E of the four light-emitting element rows ER1 to ER4 are caused to emit lights at the common timing can be applied, so that the light-emitting timing control is simplified.

In the second embodiment as well, the light-emitting element rows ER1 to ER4 are arranged so as to satisfy the equations 1 to 6 (that is, so as to satisfy Dr12=1×Pdt/|βs|, DR23=m×Pdt/|βs|, and Dr34=n×Pdt/|βs|). Accordingly, the respective light-emitting elements of the light-emitting element rows ER1 to ER4 are caused to emit lights at the common timing to irradiate the pixels on the surface of the photosensitive drum 21 with the spots, so that the light-emitting timing control is simplified.

### C. Resolution

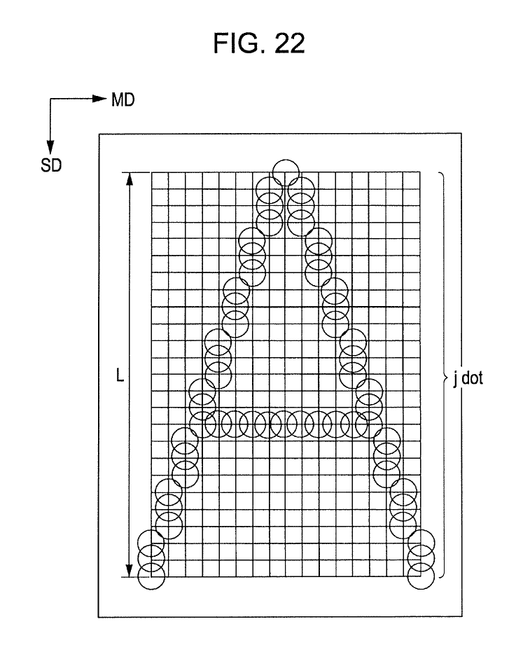

The resolution will be described here. FIG. 22 is a drawing for explaining a definition of resolution. The resolution is provided by a density of dots in a formed image. In FIG. 22, a case where an alphabet “A” is formed as an image is exemplified. The spots SP (circular marks in FIG. 22) are directed to the intersections of the grid in the same drawing according to the image data, and the toner is attached to portions exposed by the spots SP. In other words, the intersections of the grid correspond to the centers (geometrical centers of gravity) of the dots.

A length of the area where the alphabet “A” is formed in the secondary scanning direction SD is expressed by L, and the number of dots included in the length L (the number of dots arranged in the secondary scanning direction) is expressed by j, the dot pitch Pdt satisfies;

Pdt=L/(j−1).

If a resolution R in the secondary scanning direction is defined by the number of dots to be written in one inch and P is expressed by the unit of millimeter, the resolution R is given by;

R=25.4/Pdt [dpi].

This is the definition of the resolution R. When implementing the invention described above, by setting a distance P0 between the light-emitting element rows on the basis of the following equation;

P0=Pdt/|βs|=L/(|βs|×(j−1),

the light-emitting timing control such as to cause lights to be emitted at the common timing can be applied, so that the light-emitting timing control is simplified.

When obtaining the resolution R from the image actually formed according to the definition described above, L is desirably set to satisfy the relationship j<100 (j=25 in FIG. 22). Accordingly, the influence of the error of the dot pitch Pdt is restrained, and hence the resolution R can be obtained with high degree of accuracy.

When forming the image, the tolerance of variations of the dot pitch Pdt is on the order of ±3 [μm] from the results of the print evaluation at both 2400 dpi and 600 dpi. If it exceeds this value, formed images are subjected to obvious unevenness in density. Therefore, in order to avoid such unevenness in density, the accuracy of the distance between the light-emitting element rows ER1 to ER4 needs to satisfy a range of ±3 [μm]/|β|.

### D. Others

In this manner, in this embodiment, the line head 29 corresponds to the “exposure head” in the invention, and the photosensitive drum 21 corresponds to the “latent image carrier” in the invention. The light-emitting element E of the light-emitting element row ER1 corresponds to “first light-emitting element” or “second light-emitting element” in the invention, the light-emitting element E of the light-emitting element row ER2 corresponds to “third light-emitting element” in the invention, the light-emitting element E of the light-emitting element row ER3 corresponds to the “fourth light-emitting element” in the invention, the light-emitting element E in the light-emitting element row ER4 corresponds to “fifth light-emitting element” in the invention, the distance Dr12 corresponds to “distance Dr12 in the direction orthogonal to the first direction between the first light-emitting element and the second light-emitting element”, the distance Dr23 corresponds to “distance Dr23 in the direction orthogonal to the first direction between the third light-emitting element and the fourth light-emitting element”, the distance Dr34 corresponds to “distance Dr34 in the direction orthogonal to the first direction between the fourth light-emitting element and the fifth light-emitting element”, the head substrate 293 corresponds to the “light-emitting element substrate” in the invention, and the lenses LS1 and LS2 function as the “imaging optical system” in the invention in cooperation. The head controller HC, the data transfer substrate TB, the driver IC 295, and the drive circuits DC1 to DC4 function as the “control unit” in the invention in cooperation. The primary scanning direction MD corresponds to the “first direction” in the invention, and the secondary scanning direction SD corresponds to the “direction orthogonal to the first direction” or “direction orthogonal to the direction of an axis” in the invention. The dot pitch Pdt corresponds to the “pitch Pdt in the direction orthogonal to the first direction of the spots directed from the exposure head to the photosensitive drum” in the invention.

From among these terms, “distance between two light-emitting elements”, “pitch between two spots”, and “direction orthogonal to the axis of the surface of the photosensitive drum” can be defined as follows respectively. In other words, the geometrical center of the light-emitting element is assumed to be the position of the light-emitting element, the distance between the two light-emitting elements is defined as the distance between the geometrical centers of gravity of the respective light-emitting elements. The pitch between the two spots is defined as the distance between the geometrical centers of gravity of the developed dots. The direction orthogonal to the axis is defined as the direction of movement in the direction of a tangent line of the surface of the photosensitive drum rotating about the axis.

The invention is not limited to the embodiment described above, and various modifications may be made without departing the scope of the invention in addition to the configuration described above. Therefore, the diameter of the light-emitting element E or the intervals of arrangement of the light-emitting element rows ER1 to ER4 (Dr12, Dr23, Dr34) may also be modified in various manners. In particular, the diameter of the light-emitting element can preferably be changed according to the required resolution or the optical characteristics of the light-emitting element material to be used. More specifically, for example, in a case where the exposure at the resolution of 2400 dpi is performed by forming the light-emitting elements E of a material providing a relatively large amount of light, it may be preferable to reduce the spot diameter to the order of 15 [μm] for forming spots with high definition.

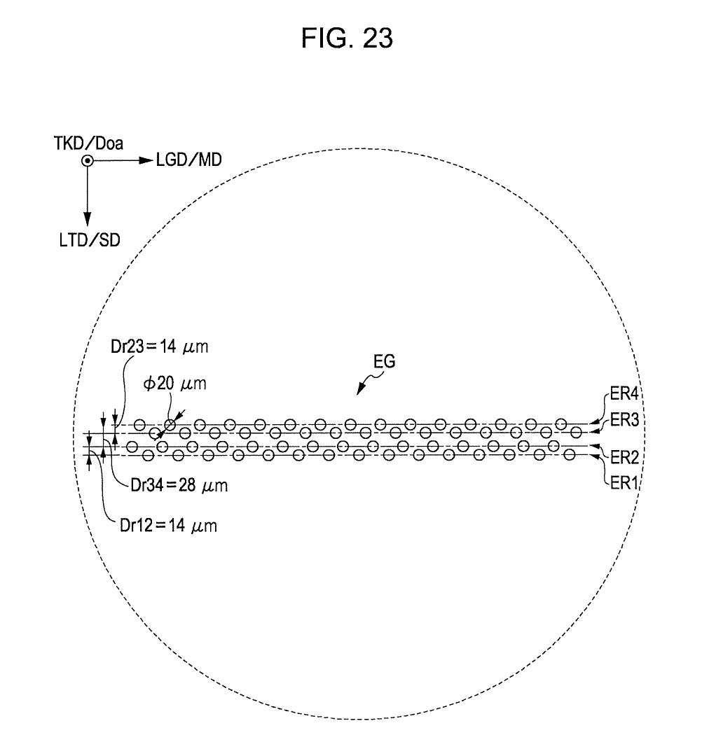

Accordingly, the light-emitting element group EG as shown in FIG. 23 may be employed. FIG. 23 is a plan view showing a modification of the configuration of the light-emitting element group. In this modification, the diameter of the light-emitting element is set to 20 [μm] (≈15/|β|) in order to realize a spot diameter of 15 [μm]. The distances Dr12, Dr34, and Dr23 between the light-emitting element rows ER1 to ER 4 satisfy the equation; Dr12:Dr23:Dr34=l:m:n=1:2:1. In this manner, the distances Dr12, Dr34, and Dr23 satisfy the ratios of whole numbers, the light-emitting timing control such that the respective light-emitting elements E of the four light-emitting element rows ER1 to ER4 are caused to emit lights at the common timing can be applied, so that the light-emitting timing control is simplified.

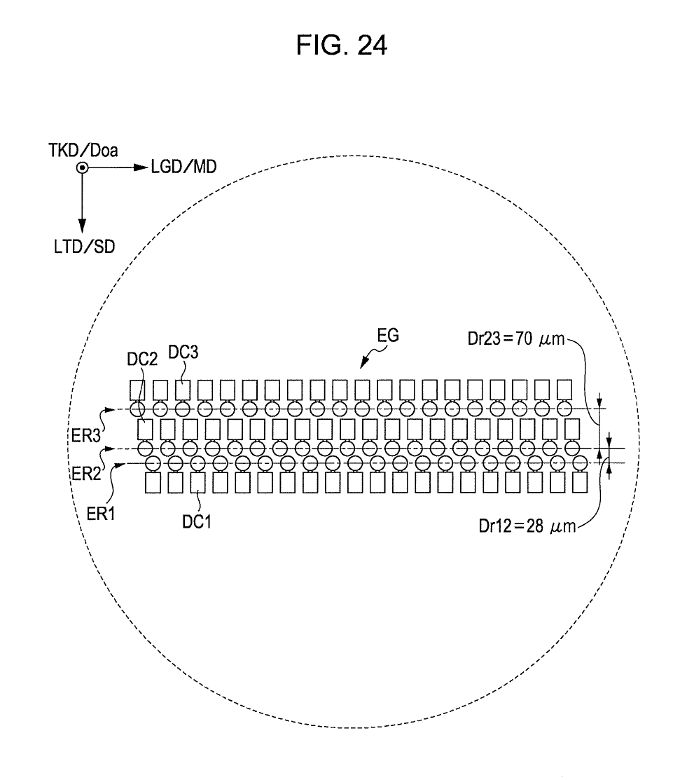

The number of rows of the light-emitting element rows in the light-emitting element group EG may be varied variously and, for example, the light-emitting element group EG as shown in FIG. 24 may be employed. FIG. 24 is a plan view showing another modification of the configuration of the light-emitting element group. In the another modification, the light-emitting element group EG includes the three light-emitting element rows ER1 to ER3. The distances Dr12 and Dr23 between the light-emitting element rows ER1 to ER3 are 28 [μm] and 70 [μm] respectively, and the equation Dr12:Dr23=l:m=2:5 is satisfied. In this manner, the distances Dr12 and Dr23 satisfy the ratios of whole numbers, the light-emitting timing control such that the respective light-emitting elements E of the three light-emitting element rows ER1 to ER3 are caused to emit lights at the common timing can be applied, so that the light-emitting timing control is simplified.

In the another modification, the integer number 1 and the integer number m satisfy the relation m>1, that is, the distance Dr23 is larger than the distance Dr12. Accordingly, on the back surface 293-t of the head substrate, a relatively large space is secured between the light-emitting element row ER2 and the light-emitting element row ER3, so that the drive circuit DC2 for driving the respective light-emitting elements E of the light-emitting element row ER2 can be formed in this space. It is also applicable to form the drive circuit DC3 instead of the drive circuit DC2 in this free space, and drive the respective light-emitting elements E of the light-emitting element row ER3 by the same drive circuit DC3.

In particular, in the another modification, the integer number m and the integer number 1 satisfy the relation m>2×1. In other words, by the configuration in which the relation m>2×1 is satisfied, the distance Dr23 is made larger than the Distance Dr12, so that a larger space can be provided between the light-emitting element row ER2 and the light-emitting element row ER3. Consequently, the drive circuit DC2 (DC3) can be disposed with sufficient room, so that the layout of the drive circuit DC2 (DC3) is facilitated.

Also, in the embodiment described above, the bottom-emission type organic EL elements are used as the light-emitting elements E. However, top-emission type organic EL elements may be used as the light-emitting elements E, or a LED (Light-emitting Diode) other than the organic EL elements may be used as the light-emitting elements E. The shape of the light-emitting element E is not limited to the circular shape as described above, and may be modified as needed.

The number of lens arrays, and the configuration of the respective lens arrays LA1 and LA2 (the mode of arrangement of the lenses, the positions to form the lenses, etc.) may be modified as needed.

The entire disclosure of Japanese Patent Applications No. 2009-273127, filed on Dec. 1, 2009 is expressly incorporated by reference herein.

What is claimed is:

1. A exposure head comprising:
a light-emitting element substrate including a first light-emitting element configured to emit light, a second light-emitting element disposed in a first direction of the first light-emitting element, a third light-emitting element, and a fourth light-emitting element disposed so as to satisfy the following relationship;
Dr12:Dr23=l:m (l≠m)
where,
l: positive integer number
m: positive integer number
Dr12: distance between the first light-emitting element and the third light-emitting element in the direction orthogonal to the first direction
Dr23: distance between the third light-emitting element and the fourth light-emitting element in the direction orthogonal to the first direction, and
an imaging optical system configured to image lights emitted from the first light-emitting element, the second light-emitting element, the third light-emitting element and the fourth light-emitting element.

2. The exposure head according to claim 1, wherein the integer number 1 and the integer number m satisfy the following relationship;
m=1+1.

3. The exposure head according to claim 1, wherein the integer number 1 and the integer number m satisfy the following relationship;
m>1,
and the light-emitting element substrate includes a drive circuit configured to drive the third light-emitting element between the third light-emitting element and the fourth light-emitting element in the direction orthogonal to the first direction.

4. The exposure head according to claim 3, wherein the integer number m and the integer number 1 satisfy the following relationship;
m>2×1.

5. The exposure head according to claim 1, wherein a fifth light-emitting element disposed in the direction different from the first direction of the first light-emitting element is disposed on the light-emitting element substrate so as to satisfy the following relationship;
Dr12:Dr23:Dr34=l:m:n
where,
n: positive integer number
Dr34: distance between the fourth light-emitting element and the fifth light-emitting element in the direction orthogonal to the first direction.

6. The exposure head according to claim 5, wherein the integer number 1, the integer number m, and the integer number n have the following expression;
l=n=m−1.

7. An image forming apparatus comprising:
an exposure head including:
a light-emitting element substrate including a first light-emitting element configured to emit light, a second light-emitting element disposed in a first direction of the first light-emitting element, a third light-emitting element, and a fourth light-emitting element disposed so as to satisfy the following relationship;
Dr12:Dr23=l:m (l≠m)
where,
l: positive integer number
m: positive integer number
Dr12: distance between the first light-emitting element and the third light-emitting element in the direction orthogonal to the first direction
Dr23: distance between the third light-emitting element and the fourth light-emitting element in the direction orthogonal to the first direction, and
an imaging optical system configured to image lights emitted from the first light-emitting element, the second light-emitting element, the third light-emitting element, and the fourth light-emitting element, and form a spot;
a photosensitive drum having an axis and being irradiated with the spot to form a latent image;
a control unit configured to cause the first light-emitting element, the second light-emitting element, the third light-emitting element, and the fourth light-emitting element to emit lights at a timing according to the movement of the surface of the photosensitive drum in the direction orthogonal to the direction of the axis; and
a developing unit configured to develop the latent image formed on the photosensitive drum.

8. The image forming apparatus according to claim 7, wherein the imaging optical system images the lights emitted from the first light-emitting element, the second light-emitting element, the third light-emitting element, and the fourth light-emitting element at a magnification of βs, and the distance Dr12 and the distance Dr23 have the following relationship;
Dr12=l×Pdt/|βs|

Dr23=m×Pdt/|βs|

Pdt: pitch of the spots directed on the photosensitive drum from the exposure head in the direction orthogonal to the first direction.
